(19) United States
(12) Patent Application Publication
(10) Pub. No.: US 2014/0368857 A1
(43) Pub. Date: Dec. 18, 2014

(54) DRIVER GENERATING APPARATUS, DRIVER GENERATING METHOD, NON-TRANSITORY COMPUTER-READABLE RECORDING MEDIUM ENCODED WITH DRIVER GENERATING PROGRAM

(71) Applicant: KONICA MINOLTA, INC., Chiyoda-ku (JP)

(72) Inventor: Tatsuo EDAMATSU, Kobe-shi (JP)

(73) Assignee: KONICA MINOLTA, INC., Chiyoda-ku (JP)

(21) Appl. No.: 14/306,463

(22) Filed: Jun. 17, 2014

(30) Foreign Application Priority Data
Jun. 18, 2013 (JP) 2013-127704

(51) Int. Cl. G06K 15/02

(52) U.S. Cl. CPC G06K 15/1806
USPC 358/1.13

(57) ABSTRACT

A driver generating apparatus includes a selecting portion to select one or more pieces of partial definition data from among a plurality of pieces of partial definition data determined by a first driver program for controlling an image processing apparatus, each piece of the partial definition data associating a control command determining a prescribed process with a display command for displaying a partial screen for accepting an operation by a user in relation to the prescribed process, and a generating portion to generate a second driver program including the selected one or more pieces of partial definition data.

This application is based on Japanese Patent Application No. 2013-127704 filed with Japan Patent Office on Jun. 18, 2013, the entire content of which is hereby incorporated by reference.

### BACKGROUND OF THE INVENTION

1. Field of the Invention

The present invention relates to a driver generating apparatus, a driver generating method, a non-transitory computer-readable recording medium encoded with a driver generating program, a control apparatus, and a non-transitory computer-readable recording medium encoded with a driver program. More particularly, the present invention relates to a driver generating apparatus which generates a driver program for controlling an image processing apparatus, a driver generating method performed in the driver generating apparatus, a non-transitory computer-readable recording medium encoded with a driver generating program executed in the driver generating apparatus.

2. Description of the Related Art

In order for a personal computer (hereinafter, referred to as a “PC”) to control an image processing apparatus, typified by a multi-function peripheral, the PC needs to have installed therein a printer driver program corresponding to the image processing apparatus. The printer driver program is usually supplied from the manufacturer which provides the corresponding image processing apparatus. Since a printer driver program corresponds to an image processing apparatus, the type of the printer driver program varies depending on the type of the image processing apparatus.

Japanese Patent Laid-Open No. 2006-227990 discloses a printing software update method in which printing software controlling a printing process from an information processing apparatus includes: a core portion which provides a universal feature of the software, and a plurality of function-dependent portions which provide functions depending upon printing, and the printing software determines whether it is necessary to update the function-dependent portions, and if so, it updates the module owned by itself, with a latest module.

Although the conventional printing software updating method makes it possible to readily update the existing function-dependent portions, when a printer driver program corresponding to a new image processing apparatus is developed, a core portion corresponding to the image processing apparatus needs to be developed.

### SUMMARY OF THE INVENTION

An aspect of the present invention provides a driver generating apparatus which includes: a selecting portion to select one or more pieces of partial definition data from among a plurality of pieces of partial definition data determined by a first driver program for controlling an image processing apparatus, each piece of the partial definition data associating a control command determining a prescribed process with a display command for displaying a partial screen for accepting an operation by a user in relation to the prescribed process; and a generating portion to generate a second driver program including the selected one or more pieces of partial definition data.

Another aspect of the present invention provides a driver generating method for causing a computer to perform: a selecting step of selecting one or more pieces of partial definition data from among a plurality of pieces of partial definition data determined by a first driver program for controlling an image processing apparatus, each piece of the partial definition data associating a control command determining a prescribed process with a display command for displaying a partial screen for accepting an operation by a user in relation to the prescribed process; and a generating step of generating a second driver program including the selected one or more pieces of partial definition data.

A further aspect of the present invention provides a non-transitory computer-readable recording medium encoded with a driver generating program for causing a computer to perform: a selecting step of selecting one or more pieces of partial definition data from among a plurality of pieces of partial definition data determined by a first driver program for controlling an image processing apparatus, each piece of the partial definition data associating a control command determining a prescribed process with a display command for displaying a partial screen for accepting an operation by a user in relation to the prescribed process; and a generating step of generating a second driver program including the selected one or more pieces of partial definition data.

The foregoing and other features, aspects, and advantages of the present invention will become more apparent from the following detailed description of the present invention when taken in conjunction with the accompanying drawings.

### BRIEF DESCRIPTION OF THE DRAWINGS

FIG. 1 schematically shows a print system according to an embodiment of the present invention;

FIG. 2 is a perspective view of an MFP;

FIG. 3 is a block diagram showing, by way of example, the hardware configuration of the MFP;

FIG. 4 is a block diagram showing, by way of example, the hardware configuration of a PC;

FIG. 5 is a block diagram showing, by way of example, the functions when a CPU included in the PC executes a first driver program, together with data stored in a HDD;

FIG. 6 shows an example of function definition data;

FIG. 7 shows another example of the function definition data;

FIG. 8 shows an example of a setting screen;

FIG. 9 shows an example of an editing screen;

FIG. 10 is a block diagram showing, by way of example, the functions when the CPU included in the PC executes a driver generating program and a driver program, together with data stored in the HDD;

FIG. 11 shows an example of a display screen;

FIGS. 12 and 13 show a flowchart illustrating an example of the flow of a setting process;

FIG. 14 illustrates an example of the flow of an editing screen displaying process;

FIG. 15 is a flowchart illustrating an example of the flow of a print job generating process;

FIG. 16 is a flowchart illustrating an example of the flow of a driver generating process;

FIG. 17 is a block diagram showing, by way of example, the functions when the CPU included in the PC executes a driver generating program according to a modification, together with data stored in the HDD;

FIG. 18 shows, by way of example, the detailed functions of a first driver screen displaying portion according to the modification;

FIG. 19 is a flowchart illustrating an example of the flow of the driver generating process according to the modification; and

FIG. 20 illustrates an example of the flow of a first setting screen displaying process according to the modification.

### DESCRIPTION OF THE PREFERRED EMBODIMENTS

The preferred embodiments of the present invention will be described below in conjunction with the drawings. In the following description, the same or corresponding parts are denoted by the same reference characters. Their names and functions are also the same. Thus, a detailed description thereof will not be repeated.

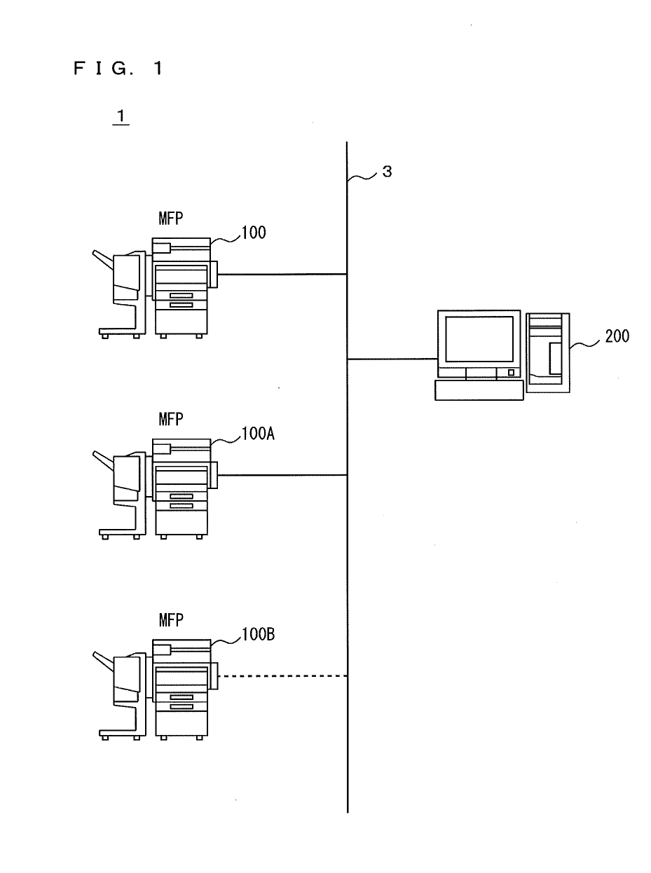

FIG. 1 schematically shows a print system according to an embodiment of the present invention. Referring to FIG. 1, a print system 1 includes multi-function peripherals (hereinafter, referred to as “MFPs”) 100 and 100A, each functioning as an image processing apparatus, and a personal computer (hereinafter, referred to as “PC”) 200.

A network 3 is a local area network (LAN), which may be connected in a wired or wireless manner. Network 3 is not necessarily the LAN; it may be a wide area network (WAN), a public switched telephone network (PSTN), the Internet, or the like.

MFPs 100 and 100A, and PC 200 are each connected to network 3. While it is shown in FIG. 1 that two MFPs 100 and 100A and one PC 200 are connected to network 3, the number of MFPs and the number of PCs connected to network 3 are not limited to those numbers; at least one MFP and at least one PC may be connected to network 3. Further, another image processing apparatus which PC 200 is able to control may be used instead of MFPs 100 and 100A. Examples of the image processing apparatus that PC 200 is able to control include, for example, image forming apparatuses such as a scanner device, a facsimile machine, and a printer, display apparatuses such as a projection television set and a projection apparatus, and a storage device which stores data.

MFPs 100 and 100A have the same hardware configuration and functions, and therefore, the hardware configuration and functions of MFP 100 will be described below representatively. It is noted that the hardware configuration and functions of MFP 100 may be different from those of MFP 100A.

In print system 1 according to the present embodiment, PC 200 has installed therein driver programs for controlling the respective MFPs 100 and 100A. The driver program for controlling MFP 100 is different from the driver program for controlling MFP 100A.

It is here assumed that a driver program for controlling an MFP 100B as a new image processing apparatus is generated in PC 200. Hereinafter, for the purposes of description, the printer driver program for controlling MFP 100 is referred to as a “first driver program”, the printer driver program for controlling MFP 100A is referred to as a “third driver program”, and a printer driver program newly generated for controlling MFP 100B is referred to as a “second driver program”.

Therefore, PC 200 has the first driver program and the third driver program installed therein. PC 200 uses at least one of the first and third driver programs which have been installed therein, to generate the second driver program.

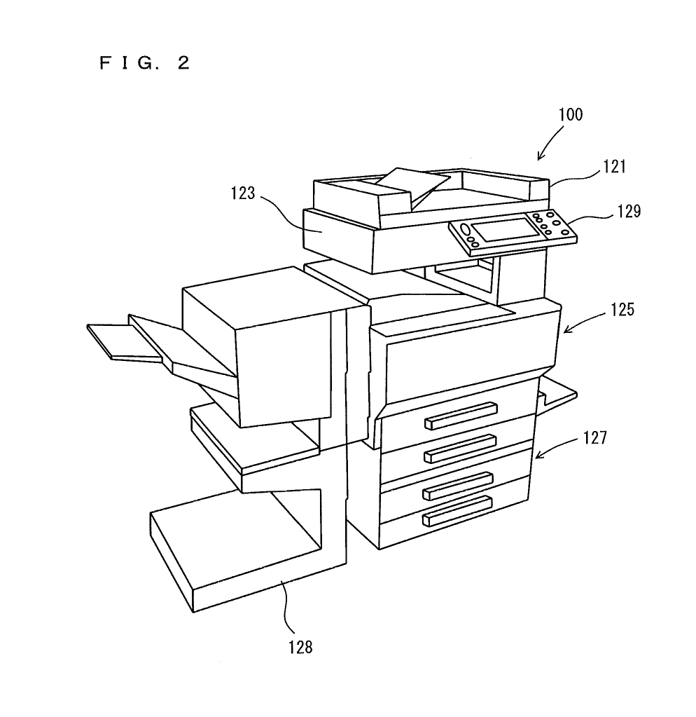

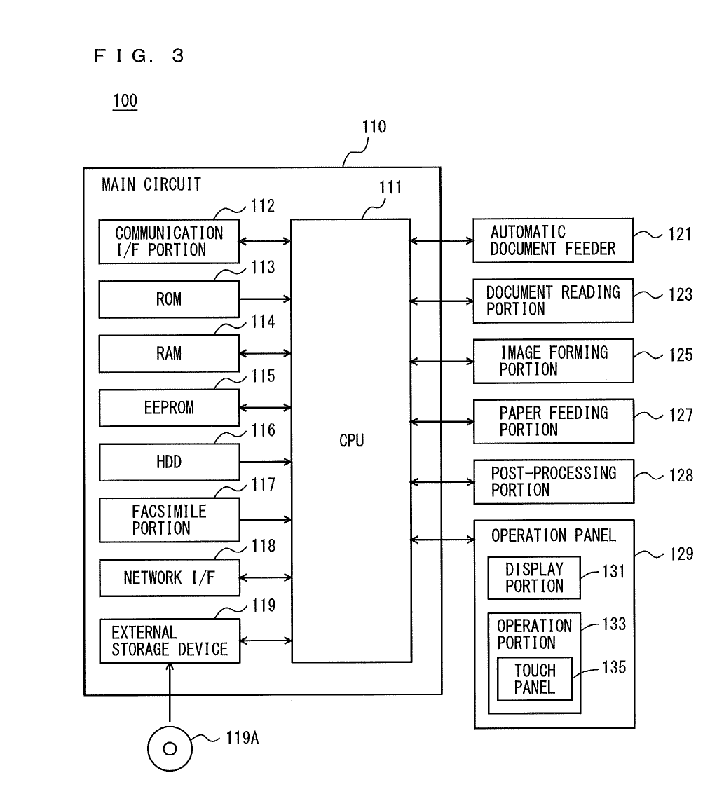

FIG. 2 is a perspective view of the MFP. FIG. 3 is a block diagram showing an exemplary hardware configuration of the MFP. Referring to FIGS. 2 and 3, MFP 100 includes: an automatic document feeder 121; a document reading portion 123; an image forming portion 125 which forms an image on a sheet of paper or the like on the basis of image data output from document reading portion 123 that has read a document; a paper feeding portion 127 which supplies sheets of paper to image forming portion 125; a post-processing portion 128 which processes sheets of paper on which images have been formed; an operation panel 129 serving as a user interface; and a main circuit 110.

Automatic document feeder 121 automatically feeds a plurality of documents set on a document feed tray, one by one, to a predetermined document reading position set on a platen glass of document reading portion 123, and outputs the document, the image of which has been read by document reading portion 123, onto a document output tray. Document reading portion 123 includes an optical source which irradiates a document placed on the document reading position with light and a photoelectric conversion element which receives light reflected from the document, and scans a document image having a size corresponding to that of the document. The photoelectric conversion element converts the received light into image data made up of electric signals, and outputs the image data to image forming portion 125. Paper feeding portion 127 feeds a sheet of paper, stored in a paper feed tray, to image forming portion 125.

Image forming portion 125 forms an image using well-known electrophotography. Image forming portion 125 performs various kinds of image processing such as shading compensation on image data received from the outside or input from document reading portion 123 and, on the basis of the processed image data, forms an image on a sheet of paper fed by paper feeding portion 127.

Post-processing portion 128 discharges sheets of paper having images formed thereon. Post-processing portion 128 has a plurality of paper discharge trays, and can sort and discharge a plurality of sheets with the images formed thereon. Further, post-processing portion 128 includes a hole-punching portion and a stapling portion, and can punch or staple the discharged sheets. MFP 100 further has, on its upper surface, operation panel 129 as a user interface.

Main circuit 110 includes a CPU 111, a communication interface (I/F) portion 112, a read only memory (ROM) 113, a random access memory (RAM) 114, an electrically erasable and programmable ROM (EEPROM) 115, a hard disk drive (HDD) 116 as a mass storage, a facsimile portion 117, a network I/F 118; and an external storage device 119 to which a compact disc ROM (CD-ROM) 119A may be mounted. CPU 111 is connected with automatic document feeder 121, document reading portion 123, image forming portion 125, paper feeding portion 127, post-processing portion 128, and operation panel 129, and is responsible for overall control of MFP 100.

ROM 113 stores a program executed by CPU 111 or data necessary for execution of the program. RAM 114 is used as a work area when CPU 111 executes a program. Further, RAM 114 temporarily stores read data (image data) continuously transmitted from document reading portion 123.

Operation panel 129 is disposed on the upper surface of MFP 100. Operation panel 129 includes a display portion 131 and an operation portion 133. Display portion 131 is a display such as a liquid crystal display (LCD) or an organic electro-luminescence display (ELD), and displays an instruction menu for the user, information about acquired image data, and others. Operation portion 133 is provided with a plurality of keys, and accepts input data such as instructions, characters, and numerical characters, according to the key operations by the user. Operation portion 133 further includes a touch panel 135 which detects a position on the display surface of display portion 131. Touch panel 135 is disposed on an upper or lower surface of display portion 131, and outputs the coordinates of a position designated by a user, to CPU 111.

Communication I/F portion 112 is an interface for connecting MFP 100 to an external device. Network I/F 118 is an interface for connecting MFP 100 to network 3. CPU 111 communicates with PC 200 connected to network 3 via network I/F 118 for data transmission/reception. Network I/F 118 is also able to communicate with a computer connected to the Internet via network 3.

Facsimile portion 117 is connected to public switched telephone networks (PSTN), and transmits facsimile data to or receives facsimile data from the PSTN. Facsimile portion 117 converts the data of the image read by document reading portion 123, or the data stored in HDD 116, into facsimile data, and transmits the facsimile data to a facsimile machine connected to the PSTN. When receiving facsimile data, facsimile portion 117 stores the received data into HDD 116, or causes image forming portion 125 to form an image of the facsimile data on a sheet of paper.

External storage device 119 is mounted with CD-ROM 119A. CPU 111 is capable of accessing CD-ROM 119A via external storage device 119. CPU 111 loads the program stored in CD-ROM 119A which is mounted on external storage device 119, into RAM 114 for execution.

It is noted that a program executed by CPU 111 is not restricted to a program stored in CD-ROM 119A; a program stored in HDD 116 may be loaded into RAM 114 for execution. In this case, another computer connected to network 3 may rewrite the program stored in HDD 116 of MFP 100, or may additionally write a new program therein. Further, MFP 100 may download a program from another computer connected to the network, and store the program in HDD 116. As used herein, the “program” includes, not only the program which CPU 111 can execute directly, but also a source program, a compressed program, an encrypted program, and others.

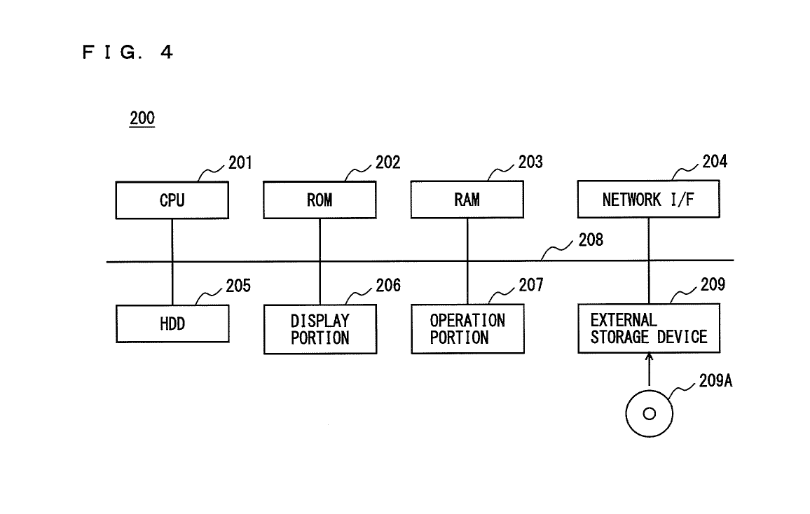

FIG. 4 is a block diagram showing an exemplary hardware configuration of the PC. Referring to FIG. 4, PC 200 includes: a CPU 201, a ROM 202, a RAM 203, a network I/F 204, a HDD 205, a display portion 206, an operation portion 207, and an external storage device 209, which are each connected to a bus 208.

CPU 201 is responsible for overall control of PC 200. ROM 202 stores a program executed by CPU 201. RAM 203 is used as a work area for CPU 201. Network I/F 204 is an interface for connecting PC 200 to network 3. HDD 205, which is a mass storage, stores data in a non-volatile manner. Display portion 206 is a display such as an LCD, a cathode ray tube (CDT), or an organic ELD. Operation portion 207 includes a keyboard and pointing devices such as a mouse and a touch panel, and accepts an input of an operation by a user.

External storage device 209 is mounted with a CD-ROM 209A. CPU 201 loads a program stored in CD-ROM 209A, via external storage device 209, into RAM 203 for execution. It is noted that the recording medium for storing the program is not restricted to CD-ROM 209A. It may be a flexible disk, a cassette tape, an optical disc (magneto-optical (MO) disc, mini disc (MD), digital versatile disc (DVD)), an IC card, an optical card, or a semiconductor memory such as a mask ROM, an erasable programmable ROM (EPROM), an electrically erasable and programmable ROM (EEPROM), or the like. Further, the program stored in HDD 205 may be loaded into RAM 203 for execution. In this case, PC 200 may download a program from another computer connected to network 3 and store the program in HDD 205. As used herein, the “program” includes, not only the program which CPU 201 can execute directly, but also a source program, a compressed program, an encrypted program, and others.

The first driver program and the third driver program will now be described. Each of the first driver program and the third driver program includes common definition data and setting screen information. The first driver program and the third driver program are different from each other only in the setting screen information. The procedures of the processes which PC 200 performs by using the setting screen information of the first driver program and the third driver program are the same. Therefore, a description will be made below of the case where CPU 201 included in PC 200 executes the first driver program.

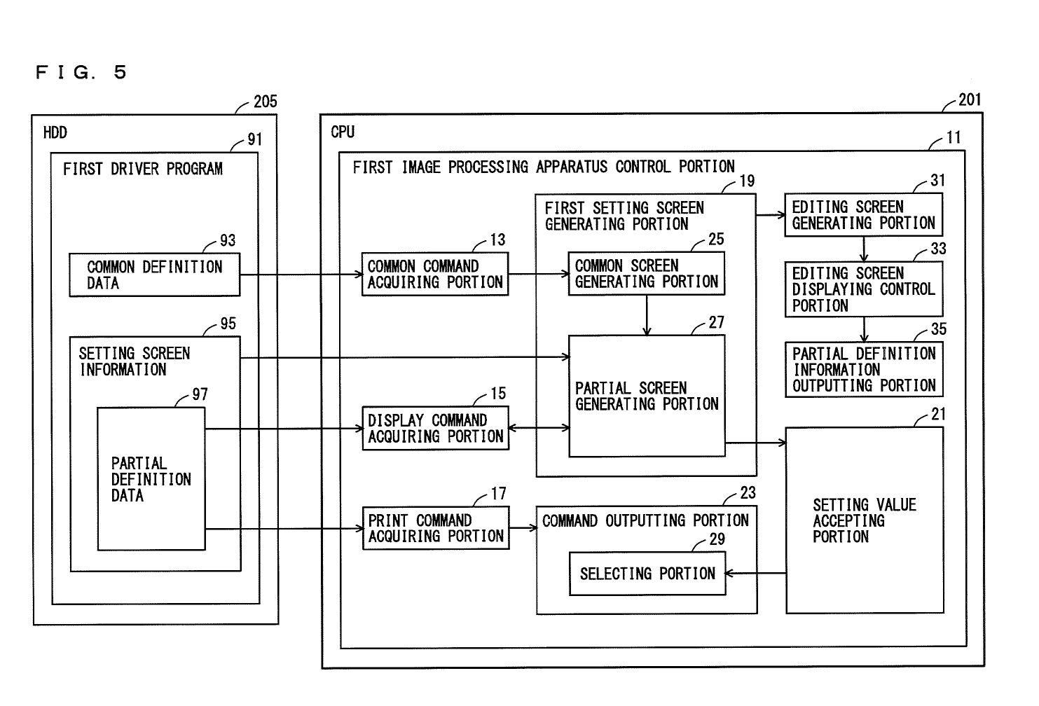

FIG. 5 is a block diagram showing, by way of example, the functions when the CPU included in the PC executes the first driver program, together with data stored in the HDD. The functions shown in FIG. 5 are formed in CPU 201 included in PC 200 as CPU 201 executes the first driver program stored in HDD 205 or CD-ROM 209A.

Referring to FIG. 5, CPU 201 included in PC 200 includes a first image processing apparatus control portion 11 as a task for CPU 201 to execute the first driver program. In order to control MFP 100, first image processing apparatus control portion 11 generates commands for causing MFP 100 to perform a plurality of functions included in MFP 100, and outputs the commands to MFP 100. A command has a setting value determined for a corresponding function. For example, for causing MFP 100 to form an image of print data, first image processing apparatus control portion 11 generates a command having a setting value determined for causing MFP 100 to execute a function of forming an image, and outputs the command to MFP 100. Examples of the functions of MFP 100 when MFP 100 performs a printing process of forming an image of data include: a function of determining the size of a sheet of paper on which an image is formed; a function of determining the direction in which an image is formed on a sheet of paper; a function of enlarging the image in size; and a function of determining the paper feed tray in which a sheet of paper is stored.

First image processing apparatus control portion 11 displays a setting screen on display portion 206, as a user interface for the user to set a setting value for each of one or more functions. The setting screen includes a common screen, a tab selecting screen, and a tab screen. The tab screen is a screen for grouping a plurality of functions of MFP 100, and for setting a setting value for each of one or more functions for each of the groups. The tab selecting screen is a screen for selecting a tab screen. The tab screen includes one or more partial screens. The partial screens include: a function-based screen, for each of the functions included in MFP 100, for setting a setting value corresponding to the function; and an instruction-based screen for accepting an instruction by a user. The common screen is a screen for providing information to a user, or for accepting an instruction by a user, independently of the functions of MFP 100.

First image processing apparatus control portion 11 includes a common command acquiring portion 13, a display command acquiring portion 15, a print command acquiring portion 17, a first setting screen generating portion 19, a setting value accepting portion 21, a command outputting portion 23, an editing screen generating portion 31, an editing screen displaying control portion 33, and a partial definition information outputting portion 35.

HDD 205 stores a first driver program 91. First driver program 91 includes common definition data 93 and setting screen information 95. Common definition data 93 determines a layout of the setting screen, and includes a common command for generating a common screen. The common command is a command for displaying a common screen which is independent of the functions included in MFP 100. Common definition data 93 includes layout information which determines areas, within the setting screen, in which a tab selecting screen and a tab screen are arranged. The tab selecting screen and the tab screen will be described later.

Setting screen information 95 includes one or more pieces of partial definition data 97 for each of one or more tab screens. One tab screen includes one or more partial screens. Setting screen information 95 includes, for each tab screen, one or more pieces of partial definition data 97 corresponding respectively to the one or more partial screens included in the tab screen.

Partial definition data 97 includes function definition data and instruction definition data. Of partial definition data 97, the function definition data determines, for each of a plurality of functions included in MFP 100, one or more print commands for causing MFP 100 to perform the function, and a display command corresponding to the function. There is/are one or more print commands for each of the plurality of functions included in MFP 100, and the one or more print commands each correspond to one of one or more setting values which can be set for the corresponding function. The function definition data associates each of the one or more print commands determined for each of the plurality of functions of MFP 100, with a setting value.

The print command is a command for causing MFP 100 to perform a function corresponding to the print command, in accordance with a setting value corresponding to the print command. The print command is a command which can be interpreted by MFP 100, and a command which has been predetermined between MFP 100 and PC 200. The print command is preferably described in print job language (PJL), printer control language (PCL), XML paper specification (XPS), PrintTicket, or PostScript (PS).

The display command is a command for causing CPU 201 to generate a partial screen. The display command includes position information indicating a position in a tab screen at which the partial screen is arranged, and component specification information which specifies a component to be displayed. The component to be displayed on display portion 206 by CPU 201 is an image prepared in advance, which may be, for example, a pop-up window, a combo box, a list box, or a radio button.

The display command included in the function definition data is a command which corresponds to one of the plurality of functions included in MFP 100 and which displays, as a partial screen, a function-based screen for setting a setting value for that function. Hereinafter, the partial screen which is displayed in accordance with a display command included in the function definition data may be referred to as a “function-based screen”.

Of partial definition data 97, the instruction definition data determines, for each of a plurality of operations which can be input by a user, a process executing command determining a process corresponding to the operation, and a display command corresponding to the operation. The process executing command is a command for causing CPU 201 to perform a process corresponding to the operation input by a user. For example, a process executing command causes CPU 201 to perform a process of confirming a setting value, a process of displaying a pop-up screen, or a process of generating a print job.

The display command included in the instruction definition data is a command for displaying, as a partial screen, an instruction-based screen for accepting an operation. The display command included in the instruction definition data corresponds to one of the plurality of operations which can be input by a user. Hereinafter, the partial screen which is displayed in accordance with a display command included in the instruction definition data may be referred to as an “instruction-based screen”.

A tab screen has its content determined by the display command included in partial definition data 97. The tab screen may include one partial screen generated by one display command, or a plurality of partial screens generated by a plurality of display commands, respectively. In the case where a tab screen includes a plurality of partial screens, a plurality of display commands have been assigned to the same tab screen. In other words, in the case where a tab screen includes a plurality of partial screens, setting screen information 95 associates a plurality of pieces of partial definition data 97 with the tab screen.

Common definition data 93 and partial definition data 97 are described in markup language such as extensible markup language (XML) or program language such as C language. Therefore, common definition data 93 and partial definition data 97 can readily be changed using an editing program or the like. It is noted that common definition data 93 and partial definition data 97 may be binary data of script language, or binary data of compiled program language.

Although it is here assumed that common definition data 93 and setting screen information 95 are part of the first driver program, common definition data 93 and setting screen information 95 may be data which is separate from the first driver program and which is associated with the first driver program.

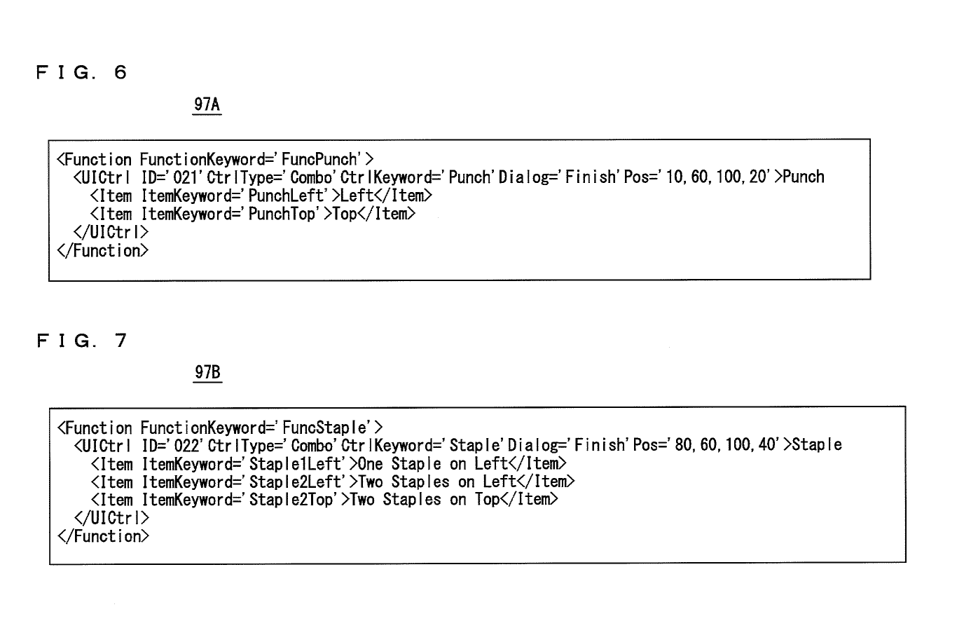

FIG. 6 shows an example of function definition data. Function definition data 97A shown in FIG. 6 corresponds to a punching function. Referring to FIG. 6, a description “FuncPunch” in the first line indicates that function definition data 97A corresponds to the punching function. The setting value which can be set for the punching function is a value specifying the position at which sheet(s) of paper is/are punched. It is here assumed that two positions, left and top of the sheet(s), can be specified. Descriptions about print commands corresponding respectively to the two positions are shown in the third and fourth lines.

The second line includes: component definition data identification information “ID=‘021’” for identifying the component definition data, tab screen identification information “Finish”, and descriptions of a display command. The display command includes a description “Combo” as component specification information, and a description “Pos=‘10, 60, 100, 20’” as position information indicating where in the tab screen the component is arranged. The component specification information “Combo” specifies a combo box as the component used for display. In the position information, the first two numbers show the coordinates of the position in the tab screen, the third number shows the horizontal length of the function-based screen, and the fourth number shows the vertical length of the function-based screen. These numbers determine the size and position, within the tab screen, of the rectangular function-based screen.

The description “Dialog=‘Finish’” in the second line indicates the tab screen identification information “Finish”. In other words, this description indicates that function definition data 97A is associated with the tab screen having the tab screen identification information “Finish”.

FIG. 7 shows another example of the function definition data. Function definition data 97B shown in FIG. 7 corresponds to a stapling function. Referring to FIG. 7, a description “FuncStaple” in the first line indicates that function definition data 97B corresponds to the stapling function. The setting value which can be set for the stapling function is a value specifying the number of staples used and the position at which sheets are stapled. It is here assumed that the following three setting values can be specified: one staple on the left side of sheets, two staples on the left side of sheets, and two staples on the top side of sheets. Descriptions about print commands corresponding respectively to the three setting values are shown in the third through fifth lines.

The second line includes: component definition data identification information “ID=‘022’” for identifying the component definition data, tab screen identification information “Finish”, and descriptions of a display command. The display command includes a description “Combo” as component specification information, and a description “Pos=‘80, 60, 100, 40’” as position information indicating where in the tab screen the component is arranged. The component specification information “Combo” specifies a combo box as the component used for display. In the position information, the first two numbers show the coordinates of the position in the tab screen, the third number shows the horizontal length of the function-based screen, and the fourth number shows the vertical length of the function-based screen. These numbers determine the size and position, within the tab screen, of the rectangular function-based screen.

The description “Dialog=‘Finish’” in the second line indicates the tab screen identification information “Finish”. In other words, this description indicates that function definition data 97B is associated with the tab screen having the tab screen identification information “Finish”.

Among a plurality of pieces of partial definition data 97 included in setting screen information 95, one or more pieces of partial definition data 97 are associated with one tab screen. As a result, a plurality of display commands may be associated with one tab screen. For example, when function definition data 97A corresponding to the punching function shown in FIG. 6 and function definition data 97B corresponding to the stapling function shown in FIG. 7 are associated with the same tab screen, a function-based screen including a combo box corresponding to the punching function and a function-based screen including a combo box corresponding to the stapling function are displayed on the same tab screen at the same time. In other words, one tab screen includes one or more partial screens which are determined by one or more pieces of partial definition data 97 associated with the tab screen, among a plurality of pieces of partial definition data 97 included in setting screen information 95.

Returning to FIG. 5, common command acquiring portion 13 reads common definition data 93 stored in HDD 205, and outputs common definition data 93 to first setting screen generating portion 19.

First setting screen generating portion 19 includes a common screen generating portion 25 and a partial screen generating portion 27. Common screen generating portion 25 receives common definition data 93 from common command acquiring portion 13, and determines the layout of the setting screen in accordance with common definition data 93. Specifically, common screen generating portion 25 generates layout information on the basis of an area for arranging a tab screen and an area for arranging a tab selecting screen, which are determined by common definition data 93. The layout information determines positions of the common screen, the tab selecting screen, and the tab screen included in the setting screen. Common screen generating portion 25 outputs the layout information to partial screen generating portion 27. The layout information determined by common definition data 93 in this manner ensures uniformity in design of the setting screen displayed on display portion 206.

Partial screen generating portion 27 generates a tab screen by selecting one from among one or more tab screens. Partial screen generating portion 27 displays a tab selecting screen for selecting a tab screen from among one or more tab screens, and selects the tab screen selected by a user. Before an input of a user's selecting operation, an arbitrary tab screen such as a default tab screen may be selected.

Specifically, one or more tab screens have been determined by setting screen information 95 stored in HDD 205, and partial screen generating portion 27 generates a tab selecting screen for selecting a tab screen from among the one or more tab screens. The tab selecting screen is a screen which includes one or more names corresponding respectively to the one or more tab screens and in which the names of the tab screens area arranged in a selectable manner. Partial screen generating portion 27 displays the generated tab selecting screen on display portion 206. At this time, partial screen generating portion 27 places the tab selecting screen, within the setting screen, at the position determined by the layout information.

Partial screen generating portion 27 outputs an acquiring instruction to display command acquiring portion 15, and accepts a display command acquired by display command acquiring portion 15. The acquiring instruction includes tab identification information for identifying the selected tab screen.

When display command acquiring portion 15 receives an acquiring instruction from partial screen generating portion 27, display command acquiring portion 15 reads, from among a plurality of pieces of partial definition data 97 included in setting screen information 95 stored in HDD 205, partial definition data 97 which is associated with the tab screen specified by the tab identification information included in the acquiring instruction. Display command acquiring portion 15 outputs the display command included in the read partial definition data 97, to first setting screen generating portion 19. When a plurality of pieces of partial definition data 97 are associated with the tab screen specified by the tab identification information included in the acquiring instruction, display command acquiring portion 15 outputs the plurality of display commands included in the respective pieces of partial definition data 97.

When partial screen generating portion 27 receives one or more display commands from display command acquiring portion 15, partial screen generating portion 27 generates one or more partial screens in accordance with the one or more display commands. Partial screen generating portion 27 displays a partial screen in the tab screen, by arranging a component specified by the component specification information included in the display command, at a position specified by the position information included in the display command. The position of the tab screen in the setting screen is determined by the layout information input from common screen generating portion 25.

When one display command is associated with a tab screen, the tab screen includes one partial screen generated by partial screen generating portion 27. When two or more display commands are associated with a tab screen, the tab screen includes a plurality of partial screens generated by partial screen generating portion 27. Partial screen generating portion 27 outputs one or more partial screens displayed on display portion 206, to setting value accepting portion 21 and editing screen generating portion 31.

In the case where partial definition data 97 is function definition data, partial screen generating portion 27 displays a function-based screen as a partial screen on display portion 206. In the case where partial definition data 97 is instruction definition data, partial screen generating portion 27 displays an instruction-based screen as a partial screen on display portion 206. In the case where partial screen generating portion 27 displays an instruction-based screen, when a user who operates PC 200 inputs an operation of designating a position inside the instruction-based screen, CPU 201 executes the process executing command which is included in the instruction definition data corresponding to the instruction-based screen. For example, the process executing command causes CPU 201 to perform a process of confirming a setting value, a process of displaying a pop-up screen, or a process of generating a print job.

Common screen generating portion 25 generates a common screen in accordance with a common command included in common definition data 93 input from common command acquiring portion 13, and displays the generated common screen on display portion 206. At this time, common screen generating portion 25 places the common screen, within the setting screen, at the position determined by the layout information. The process for common screen generating portion 25 to generate a common screen is similar to the process for partial screen generating portion 27 to generate a tab screen in accordance with a display command. Therefore, the common command includes a command, similar to the display command, for displaying a partial screen by arranging a component which is specified by the component specification information included in the common command.

In the case where a function-based screen is displayed by partial screen generating portion 27, setting value accepting portion 21 accepts a setting value which a user who operates PC 200 inputs to operation portion 207 in accordance with the function-based screen, as a setting value which is set for the function corresponding to the function-based screen. Setting value accepting portion 21 outputs a set of function identification information for identifying the function corresponding to the function-based screen and the accepted setting value, to command outputting portion 23. When a plurality of function-based screens are displayed by partial screen generating portion 27, setting value accepting portion 21 brings one of the plurality of function-based screens into a currently selected state in which a user can input a setting value from operation portion 207 to that screen, and accept the setting value input by the user, as the setting value which is set for the function corresponding to the function-based screen in the currently selected state.

Print command acquiring portion 17 reads function definition data from among a plurality of pieces of partial definition data 97 included in setting screen information 95 stored in HDD 205, and outputs one or more print commands for each of a plurality of functions included in the function definition data, to command outputting portion 23.

Command outputting portion 23 includes a selecting portion 29. Selecting portion 29 selects, on the basis of a set of function identification information and a setting value received from setting value accepting portion 21, one print command from among the one or more print commands for each of the plurality of functions received from print command acquiring portion 17. Specifically, selecting portion 29 extracts, from the one or more print commands for each of the plurality of functions received from print command acquiring portion 17, one or more print commands corresponding to the function which is specified by the function identification information included in the set of the function identification information and the setting value received from setting value accepting portion 21. Then, selecting portion 29 selects, from among the extracted one or more print commands, one print command which corresponds to the setting value included in the set of the function identification information and the setting value received from setting value accepting portion 21.

Even in the case where a new function is added to MFP 100 and a new print command is created, all that is needed is to add new component definition data including the new print command and a display command, to setting screen information 95 stored in HDD 205. There is no need to change the printer driver program itself. Further, partial definition data 97 is easy to change, because it is described in markup language such as XML or program language such as C language.

Command outputting portion 23 transmits the print command which has been selected by selecting portion 29, together with print data, to MFP 100 via network I/F 204.

Editing screen generating portion 31 generates an editing screen when first image processing apparatus control portion 11 is started in an edit mode. Editing screen generating portion 31 does not generate the editing screen when first image processing apparatus control portion 11 is started in a mode other than the edit mode. For example, in the case where a task for executing a driver generating program (described later) is to start first image processing apparatus control portion 11 in an edit mode, the task for executing the driver generating program outputs a command to execute a first driver program, to CPU 201. At this time, the task for executing the driver generating program outputs, to a task for executing the first driver program, a signal prompting to start up in an edit mode. Consequently, the task for executing the first driver program, i.e. first image processing apparatus control portion 11, is started in the edit mode. For example, at the time when the task for executing the driver generating program outputs the command to execute the first driver program to CPU 201, the task outputs, as an argument of the command, a signal prompting to start up in an edit mode, to CPU 201.

Editing screen generating portion 31 receives one or more partial screens from first setting screen generating portion 19. Editing screen generating portion 31 generates an editing screen by combining, to the setting screen, one or more area identification images for identifying the one or more partial screens, respectively. At this time, editing screen generating portion 31 combines the area identification images, to the setting screen, at the same positions where the corresponding partial screens displayed on display portion 206 are arranged. The area identification image includes, for example, an outline image having the same shape as the outline of the corresponding partial screen. The area identification image also includes an image of partial definition data identification information for identifying the partial definition data corresponding to the partial screen. Editing screen generating portion 31 outputs the generated editing screen to editing screen displaying control portion 33.

Editing screen displaying control portion 33 displays an editing screen on display portion 206, in place of the setting screen being displayed on display portion 206. When displaying the editing screen, editing screen displaying control portion 33 displays one or more area identification images included in the editing screen in a selectable manner. Editing screen displaying control portion 33 outputs the editing screen to partial definition information outputting portion 35.

When a user designates one of the one or more area identification images included in the editing screen, partial definition information outputting portion 35 outputs partial definition information to the task for executing the driver generating program. Specifically, when a user inputs to operation portion 207 an operation of designating a position inside any one of the one or more area identification images included in the editing screen, partial definition information outputting portion 35 outputs the partial definition information which corresponds to the area identification image designated by the user, to the task for executing the driver generating program. The partial definition information includes the area identification image, position information indicating the position at which the area identification image is displayed on display portion 206, and the partial definition data corresponding to the area identification image.

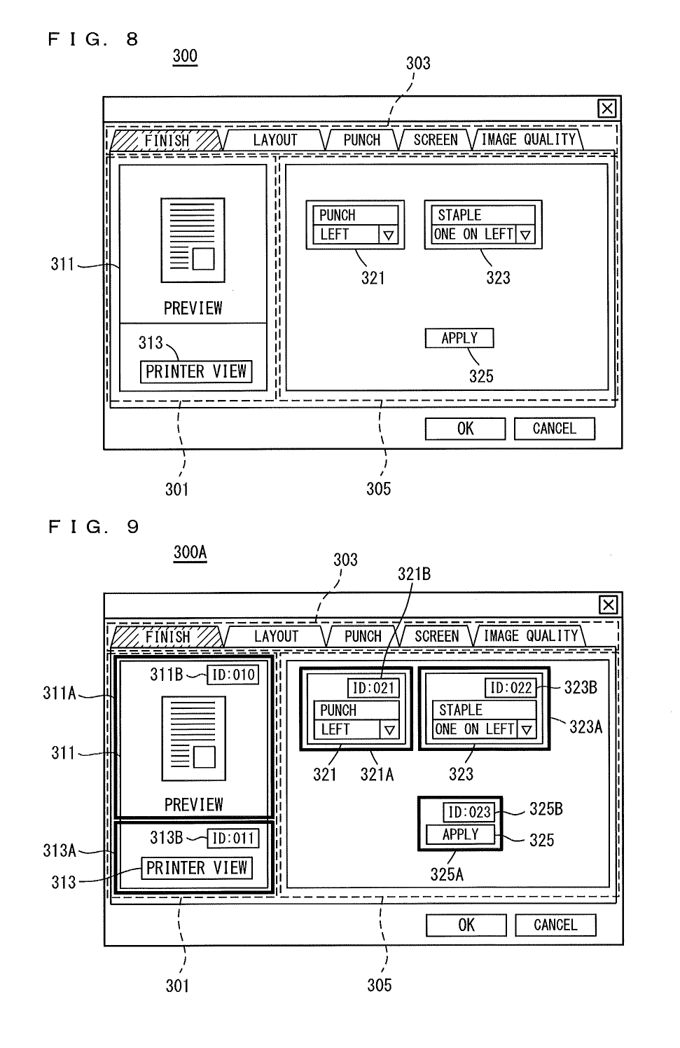

FIG. 8 shows an example of a setting screen. It is noted that the dotted lines in FIG. 8 are shown for illustration purposes only; they do not exist in the setting screen. Referring to FIG. 8, a setting screen 300 includes an area 301 for the common screen, an area 303 for the tab selecting screen, and an area 305 for the tab screen. The common screen displayed in area 301 includes an area 311 for displaying a preview image of data to be printed, and a button 313 having the characters “Printer View” displayed thereon.

The tab selecting screen displayed in area 303 includes names of a plurality of tab screens corresponding to the tab selecting screen. Shown here is the case where five selectable tab screens are arranged. It is here assumed that the tab screen named “Finish” has been selected. The tab screen displayed in area 305 includes partial screens which are generated on the basis of partial definition data 97 associated with the “Finish” tab screen.

The tab screen displayed in area 305 in FIG. 8 corresponds to the case where the partial definition data associated with the “Finish” tab screen includes function definition data 97A corresponding to the punching function shown in FIG. 6 and function definition data 97B corresponding to the stapling function shown in FIG. 7, among partial definition data 97 stored in HDD 205. More specifically, the tab screen displayed in area 305 includes a function-based screen 321 including a combo box corresponding to the punching function, and a function-based screen 323 including a combo box corresponding to the stapling function. Function-based screen 321 includes a set of the combo box and the character string “Punch”, and function-based screen 323 includes a set of the combo box and the character string “Staple”.

The tab screen displayed in area 305 also includes an instruction-based screen 325 including a button having the characters “Apply” displayed thereon. Instruction-based screen 325 is displayed on the basis of a button generating command of the instruction definition data which is included in partial definition data 97 associated with the tab screen displayed in area 305, or, the “Finish” tab screen.

When the tab screen displayed in area 305 is in the currently selected state, the combo box in function-based screen 321, the combo box in function-based screen 323, and the button in instruction-based screen 325 can be designated.

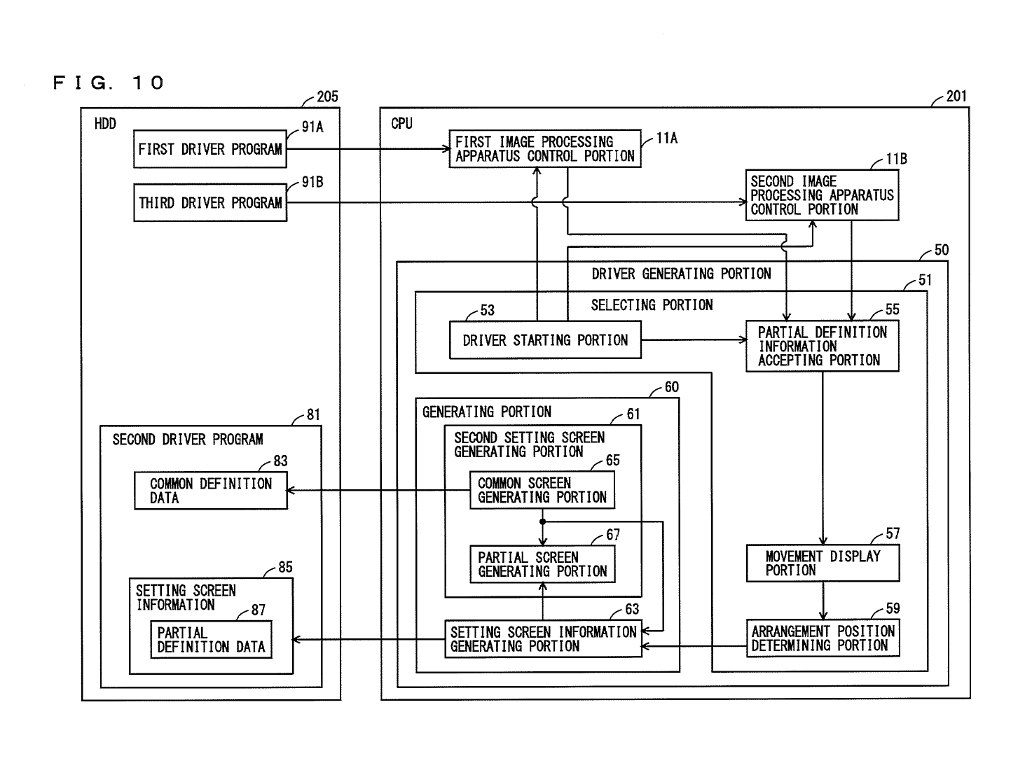

FIG. 9 shows an example of an editing screen. Shown here is an editing screen 300A which corresponds to setting screen 300 in FIG. 8. Referring to FIG. 9, editing screen 300A is a screen obtained by combining area identification images to setting screen 300 shown in FIG. 8. Therefore, the same reference characters denote the same screens as those included in setting screen 300 shown in FIG. 8.

Referring to FIG. 9, editing screen 300A includes area identification images corresponding respectively to partial screens 321, 323, and 325 which are included in area 305 for the tab screen. Specifically, editing screen 300A includes an outline image 321A enclosing the function-based screen 321 and an image 321B of partial definition data identification information “ID: 021” for identifying the function definition data corresponding to function-based screen 321. Image 321B is arranged inside outline image 321A. This allows a user to specify, from image 321B, the function definition data (partial definition data) that corresponds to function-based screen 321.

Editing screen 300A also includes an outline image 323A enclosing the function-based screen 323 and an image 323B of partial definition data identification information “ID: 022” for identifying the function definition data corresponding to function-based screen 323. Image 323B is arranged inside outline image 323A. This allows a user to specify, from image 323B, the function definition data (partial definition data) that corresponds to function-based screen 323.

Editing screen 300A also includes an outline image 325A enclosing the instruction-based screen 325 and an image 325B of partial definition data identification information “ID: 023” for identifying the instruction definition data corresponding to instruction-based screen 325. Image 325B is arranged inside outline image 325A. This allows a user to specify, from image 325B, the instruction definition data (partial definition data) that corresponds to instruction-based screen 325.

Further, editing screen 300A includes area identification images corresponding respectively to area 311 for displaying a preview image of data to be printed and button 313 having the characters “Printer View” displayed thereon, which are included in area 301 for the common screen. Specifically, editing screen 300A includes an outline image 311A enclosing the area 311 for displaying a preview image and an image 311B of command identification information “ID: 010” for identifying the command corresponding to area 311 for displaying a preview image. Image 311B is arranged inside outline image 311A. This allows a user to specify, from image 311B, the common definition data (partial definition data) corresponding to area 311 for displaying a preview image in the common screen. Editing screen 300A also includes an outline image 313A enclosing the button 313 and an image 313B of command identification information “ID: 011” for identifying the command corresponding to button 313. Image 313B is arranged inside outline image 313A. This allows a user to specify, from image 313B, the common definition data (instruction definition data) corresponding to button 313 in the common screen.

<Driver Generating Program>

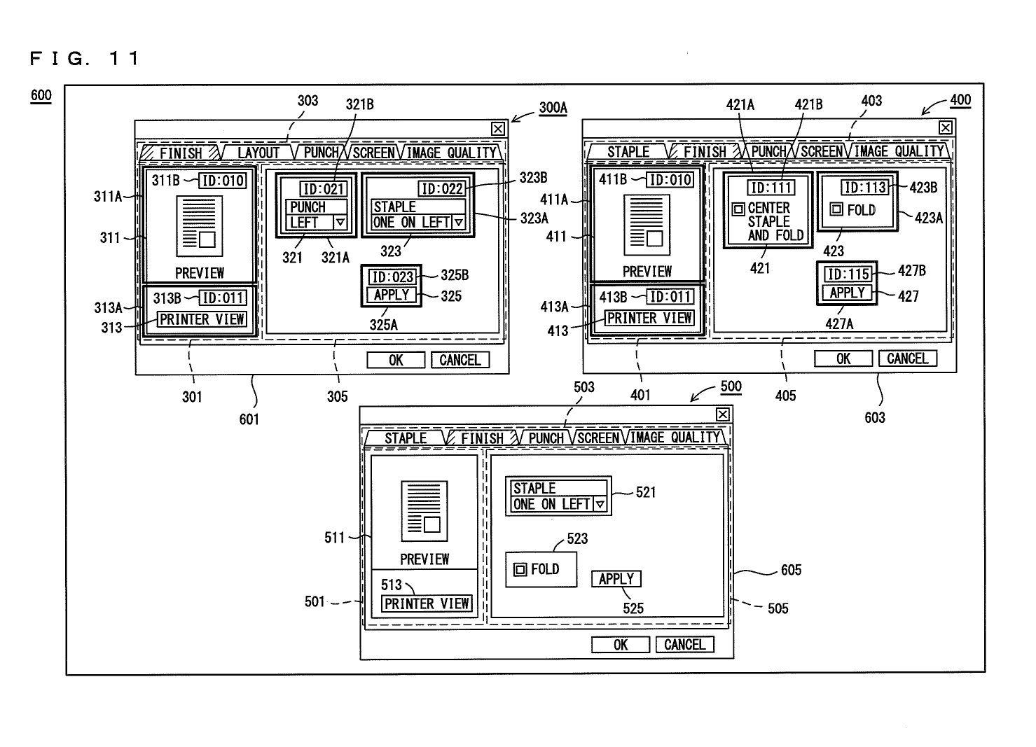

FIG. 10 is a block diagram showing, by way of example, the functions when the CPU included in the PC executes a driver generating program and a driver program, together with data stored in the HDD. The functions shown in FIG. 10 are formed in CPU 201 included in PC 200 as CPU 201 executes the driver generating program, the first driver program, and the third driver program stored in HDD 205 or CD-ROM 209A. In FIG. 10, a task for CPU 201 to execute the driver generating program is indicated as a driver generating portion 50, a task for CPU 201 to execute the first driver program is indicated as a first image processing apparatus control portion 11A, and a task for CPU 201 to execute the third driver program is indicated as a second image processing apparatus control portion 11B.

Referring to FIG. 10, CPU 201 includes: driver generating portion 50 as the task for executing the driver generating program, first image processing apparatus control portion 11A as the task for executing first driver program 91A, and second image processing apparatus control portion 11B as the task for executing third driver program 91B.

Driver generating portion 50 generates a second driver program 81, on the basis of operations by a user, by using at least part of each of first driver program 91A and third driver program 91B.

Driver generating portion 50 includes a selecting portion 51 and a generating portion 60. Selecting portion 51 includes a driver starting portion 53, a partial definition information accepting portion 55, a movement display portion 57, and an arrangement position determining portion 59. Driver starting portion 53 causes CPU 201 to execute a driver program. More specifically, driver starting portion 53 causes CPU 201 to execute the driver program that a user who operates PC 200 designates by using operation portion 207.

It is here assumed that a user operating PC 200 has designated the first driver program and the third driver program. When the first driver program is designated by the user operating PC 200, driver starting portion 53 causes CPU 201 to execute the first driver program in an edit mode. For example, driver starting portion 53 causes CPU 201 to execute a command for executing the first driver program. At this time, an argument for instructing to start the program in the edit mode is added to the command. When the command for executing the first driver program is input, CPU 201 executes the first driver program in the edit mode. Consequently, first image processing apparatus control portion 11A is formed in CPU 201. Similarly, when the third driver program is designated by the user operating PC 200, driver starting portion 53 causes CPU 201 to execute the third driver program in an edit mode. For example, driver starting portion 53 causes CPU 201 to execute a command for executing the third driver program. At this time, an argument for instructing to start the program in the edit mode is added to the command. When the command for executing the third driver program is input, CPU 201 executes the third driver program in the edit mode. Consequently, second image processing apparatus control portion 11B is formed in CPU 201.

Each of first image processing apparatus control portion 11A and second image processing apparatus control portion 11B displays an editing screen when it is started in an edit mode. The editing screen is a screen which selectably displays area identification images for identifying the partial screens. Each of first image processing apparatus control portion 11A and second image processing apparatus control portion 11B is operable, when a user selects an area identification image, to output partial definition information corresponding to the selected area identification image, to driver generating portion 50. The partial definition information includes area identification image information, and partial definition data corresponding to the area identification image. The area identification image information includes the area identification image, and position information which indicates the position where the area identification image is displayed on display portion 206.

Partial definition information accepting portion 55 accepts the partial definition information output from either first image processing apparatus control portion 11A or second image processing apparatus control portion 11B. Partial definition information accepting portion 55 outputs the accepted partial definition information to movement display portion 57.

When movement display portion 57 receives the partial definition information, movement display portion 57 movably displays, on display portion 206, the area identification image included in the partial definition information. At the stage when the partial definition information is accepted by partial definition information accepting portion 55, movement display portion 57 displays the area identification image included in the partial definition information, on the display surface of display portion 206, at the position which is specified by the position information included in the partial definition information. Movement display portion 57 then moves the area identification image in accordance with an operation of instructing to move the image, which is input to operation portion 207 by a user. While the area identification image is being moved, movement display portion 57 outputs a set of the position at which the area identification image is displayed on the display surface of display portion 206, and the partial definition data included in the partial definition information, to arrangement position determining portion 59.

Arrangement position determining portion 59 receives the set of the position of the area identification image and the partial definition data, from movement display portion 57. When arrangement position determining portion 59 detects an operation of terminating the movement input by the user to operation portion 207, arrangement position determining portion 59 determines the position of the area identification image after the movement. When arrangement position determining portion 59 determines the position of the area identification image after the movement, arrangement position determining portion 59 outputs a set of the position of the area identification image after the movement and the partial definition data, to generating portion 60.

Generating portion 60 generates a second driver program. It is here assumed that generating portion 60 stores the generated second driver program into HDD 205. Second driver program 81 includes common definition data 83 and setting screen information 85. Setting screen information 85 includes partial definition data 87.

Generating portion 60 generates a second setting screen and displays the screen on display portion 206. Concurrently, generating portion 60 generates the second driver program and stores the program into HDD 205. Generating portion 60 includes a second setting screen generating portion 61 and a setting screen information generating portion 63. Second setting screen generating portion 61 includes a common screen generating portion 65 and a partial screen generating portion 67. Common screen generating portion 65 stores common definition data of second driver program 81 in HDD 205. The common definition data has been determined by the driver generating program in advance. The common definition data may be acquired from the first driver program or the second driver program. Further, common screen generating portion 65 generates a second setting screen including a common screen, in accordance with the common command included in the common definition data, and displays the generated second setting screen on display portion 206. In the second setting screen at this stage, the common screen is included, but the tab selecting screen and the tab screen are empty, with the areas only reserved. Common screen generating portion 65 outputs area information indicating the areas for arranging the tab selecting screen and the tab screen, included in the common definition data, to setting screen information generating portion 63.

Setting screen information generating portion 63 receives a set of the position of the area identification image after the movement and the partial definition data, from arrangement position determining portion 59, and receives the area information indicating the areas for arranging the tab selecting screen and the tab screen, from common screen generating portion 65. Setting screen information generating portion 63 determines whether the position of the area identification image after the movement falls within the area for arranging the tab screen in the second setting screen. In the case where setting screen information generating portion 63 determines that the position of the area identification image after the movement falls within the area for arranging the tab screen, setting screen information generating portion 63 updates the partial definition data received from arrangement position determining portion 59, and adds the updated partial definition data to setting screen information 85 of second driver program 81 stored in HDD 205, for storage. Consequently, partial definition data 87 is added to setting screen information 85 stored in HDD 205. Setting screen information generating portion 63 updates the position information in the display command, included in the partial definition data received from arrangement position determining portion 59, with the position of the area identification image after the movement. Further, setting screen information generating portion 63 outputs the partial definition data with the updated position information, to partial screen generating portion 67.

Partial screen generating portion 67 generates a partial screen on the basis of the partial definition data which is input from setting screen information generating portion 63. When partial screen generating portion 67 receives partial definition data from setting screen information generating portion 63, partial screen generating portion 67 generates a partial screen in accordance with the display command included in the partial definition data. Partial screen generating portion 67 displays the partial screen in the tab screen displayed on display portion 206, by arranging a component specified by the component specification information included in the display command included in the partial definition data, at the position within the tab screen specified by the position information included in the display command.

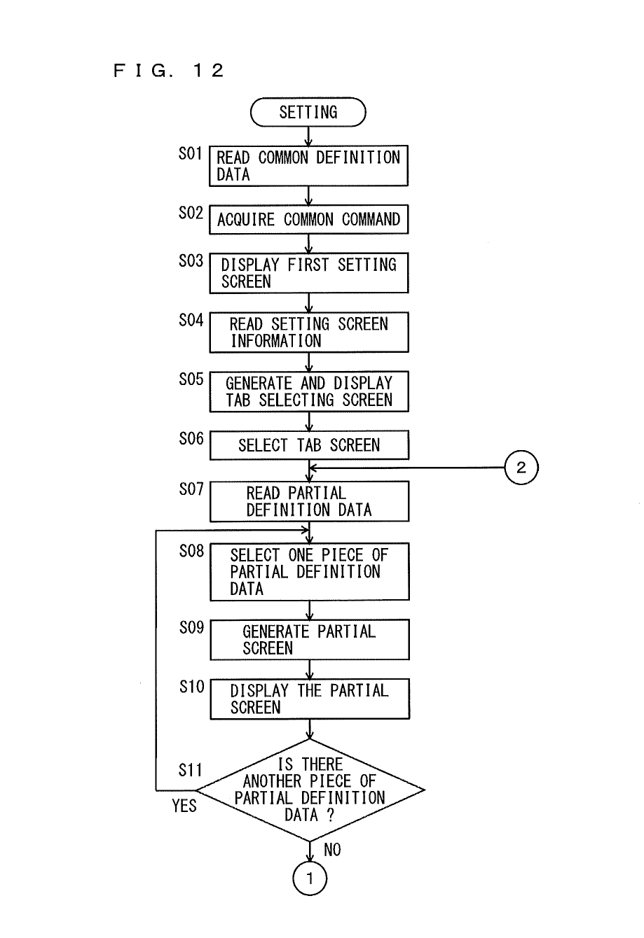

FIG. 11 shows an example of a display screen. The display screen shown in FIG. 11 is a screen displayed on display portion 206 when CPU 201 executes the driver generating program and when a user has specified first driver program 91A and third driver program 91B. It is noted that the dotted lines in FIG. 11 are shown for illustration purposes only; they do not exist in the display screen.

Referring to FIG. 11, a display screen 600 includes: a first window 601 displayed by the task for executing the first driver program, a second window 603 displayed by the task for executing the third driver program, and a third window 605 displayed by the task for executing the driver generating program.

First window 601 includes an editing screen 300A displayed by the task for executing the first driver program. Editing screen 300A is the same as the editing screen 300A shown in FIG. 9. Second window 603 includes an editing screen 400 displayed by the task for executing the third driver program.

Editing screen 400 includes an area 401 for the common screen, an area 403 for the tab selecting screen, and an area 405 for the tab screen. The common screen displayed in area 401 includes an area 411 displaying a preview image of data to be printed, and a button 413 having the characters “Printer View” displayed thereon.

The tab selecting screen displayed in area 403 includes names of tab screens corresponding to the tab selecting screen. Here, the names of five selectable tab screens are arranged. It is here assumed that the tab screen named “Finish” has been selected. The tab screen displayed in area 405 includes three partial screens 421, 423, and 427 generated on the basis of partial definition data 97 associated with the “Finish” tab screen.

The tab screen displayed in area 405 includes partial screen 421 including a checkbox corresponding to a saddle stitching (“center staple and fold”) function, partial screen 423 including a checkbox corresponding to a folding function, and partial screen 427 including a button having the characters “Apply” displayed thereon.

Editing screen 400 includes area identification images corresponding respectively to the three partial screens 421, 423, and 427 included in area 405 for the tab screen. Specifically, editing screen 400 includes an outline image 421A enclosing the partial screen 421 and an image 421B of partial definition data identification information “ID: 111” of the partial definition data corresponding to partial screen 421. Editing screen 400 also includes an outline image 423A enclosing the partial screen 423 and an image 423B of partial definition data identification information “ID: 113” of the partial definition data corresponding to partial screen 423. Editing screen 400 also includes an outline image 427A enclosing the partial screen 427 and an image 427B of partial definition data identification information “ID: 115” of the partial definition data corresponding to partial screen 427.

Further, editing screen 400 includes area identification images corresponding respectively to an area 411 for displaying a preview image of data to be printed and a button 413 having the characters “Printer View” displayed thereon, which are included in area 401 for the common screen. Specifically, editing screen 400 includes an outline image 411A enclosing the area 411 for displaying a preview image and an image 411B of partial definition data identification information “ID: 010” of the partial definition data corresponding to area 411 for displaying a preview image. Editing screen 400 also includes an outline image 413A enclosing the button 413 and an image 413B of partial definition data identification information “ID: 011” of the partial definition data corresponding to button 413.

Third window 605 includes a second setting screen 500 displayed by the task for executing the driver generating program. Second setting screen 500 includes an area 501 for the common screen, an area 503 for the tab selecting screen, and an area 505 for the tab screen. The common screen displayed in area 501 includes an area 511 displaying a preview image of data to be printed and a button 513 having the characters “Printer View” displayed thereon.

The tab screen displayed in area 505 is generated as a result of user operations of dragging outline image 323A included in editing screen 300A and dropping it onto area 505, dragging outline image 423A in editing screen 400 and dropping it onto area 505, and dragging outline image 325A in editing screen 300A and dropping it onto area 505.

The tab screen displayed in area 505 in second setting screen 500 includes a partial screen 521 including a combo box corresponding to a stapling function, a partial screen 523 including a combo box corresponding to a folding function, and a partial screen 525 including a button having the characters “Apply” displayed thereon.

Partial screen 521 is displayed through the user operation of dragging outline image 323A in editing screen 300A and dropping it onto area 505. Partial screen 521 includes a set of the combo box and the character string “Staple”. Partial screen 523 is displayed through the user operation of dragging outline image 423A in editing screen 400 and dropping it onto area 505. Partial screen 523 includes a set of the checkbox and the character string “Fold”.

Partial screen 525 is displayed through the user operation of dragging outline image 325A in editing screen 300A and dropping it onto area 505. It is noted that partial screen 525 may be displayed through a user operation of dragging outline image 427A included in editing screen 400 and dropping it onto area 505.

As explained above, at the stage when a user uses the mouse included in operation portion 207 to move the mouse pointer onto an outline image, or an area identification image, included in editing screen 300A or 400 and drag the image, the area identification image is selected. The area identification image is moved in accordance with the movement of the mouse pointer by the user. Thereafter, when the user inputs an operation of terminating the movement, for example dropping the area identification image onto area 505 in second setting screen 500, then the partial screen is displayed at that position. It is thus possible to generate second driver program 81 with simple drag-and-drop operations using the mouse.

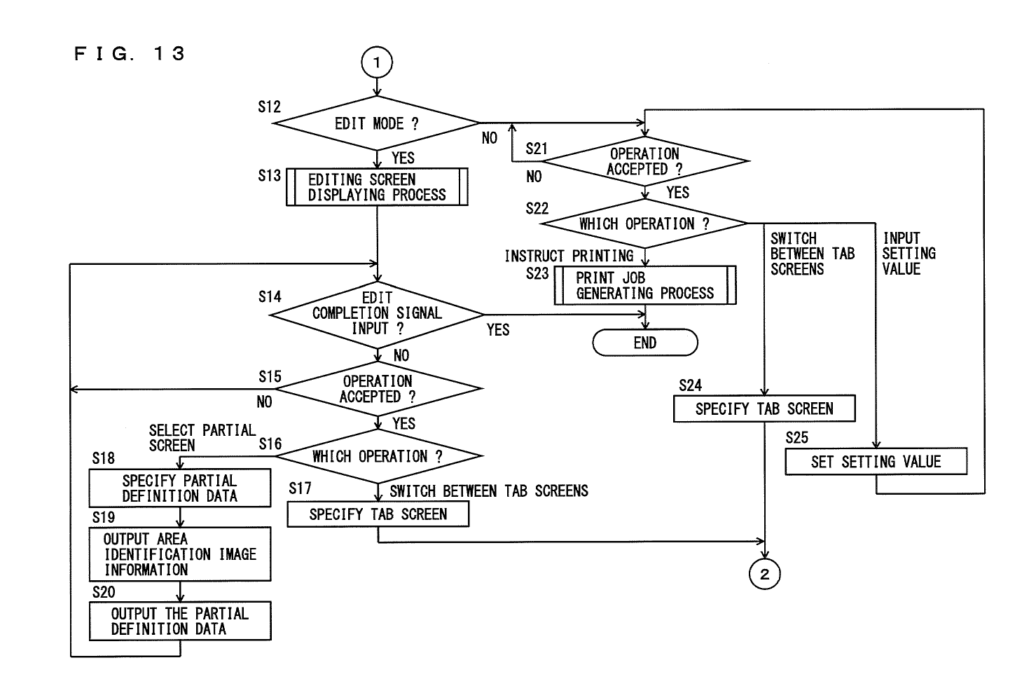

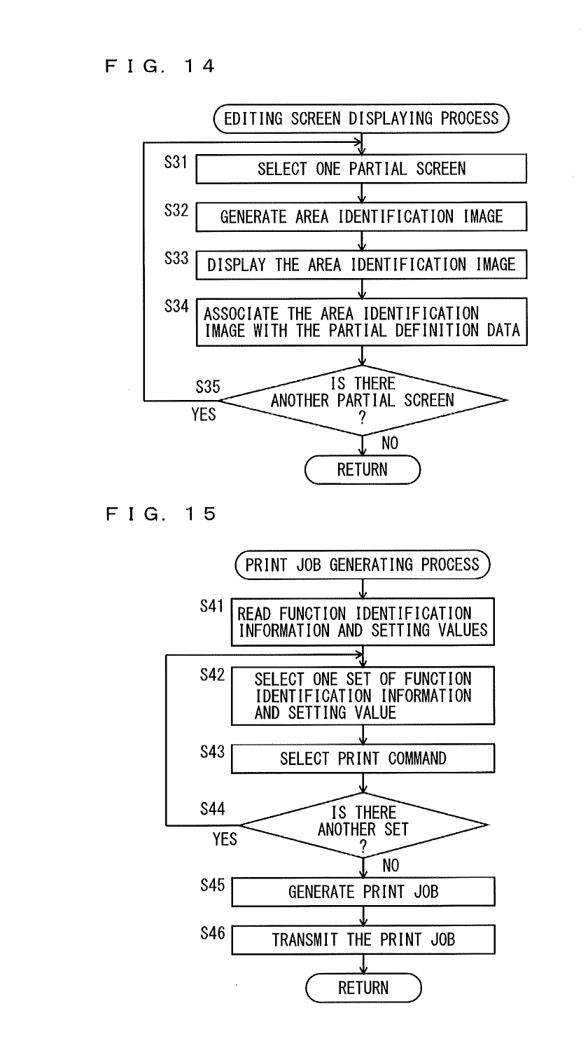

FIGS. 12 and 13 show a flowchart illustrating an example of the flow of a setting process. The setting process is carried out by CPU 201 included in PC 200 as CPU 201 executes a driver program stored in ROM 202, HDD 205, or CD-ROM 209A. It is here assumed that CPU 201 executes the first driver program corresponding to MFP 100.

Referring to FIGS. 12 and 13, CPU 201 reads common definition data 93 included in first driver program 91 stored in HDD 205 (step S01), and acquires a common command (step S02). CPU 201 extracts the common command from the read common definition data 93. CPU 201 then generates a first setting screen including a common screen, in accordance with the acquired common command, and displays the generated first setting screen on display portion 206 (step S03).

In the following step S04, CPU 201 reads setting screen information 95 included in first driver program 91 stored in HDD 205. Setting screen information 95 includes a set of one or more pieces of partial definition data 97 for each of one or more tab screens. CPU 201 then generates a tab selecting screen and displays the screen (step S05). The tab selecting screen is a screen in which one or more tab screens specified by setting screen information 95 can be selected. The tab selecting screen has images containing the names of the respective tab screens, which images are arranged in a selectable manner. CPU 201 displays the generated tab selecting screen on display portion 206 such that the screen is arranged at the position determined by the area information which is included in common definition data 93 read in step S01.

In the following step S06, CPU 201 selects a tab screen. Specifically, CPU 201 selects an arbitrary tab screen as a process target from among the one or more tab screens specified by the setting screen information read in step S04. Here, it is configured such that CPU 201 selects the first tab screen. CPU 201 then reads one or more pieces of partial definition data 97 corresponding to the tab screen as the process target, from partial definition data 97 included in the setting screen information read in step S04 (step S07). As one or more pieces of partial definition data have been assigned to one tab screen in advance, CPU 201 reads all the pieces of partial definition data 97 assigned to the tab screen as the process target.

In the following step S08, CPU 201 selects one piece of partial definition data as a process target, from among the one or more pieces of partial definition data acquired in step S07. CPU 201 generates a partial screen in accordance with the display command which is included in the partial definition data selected as the process target (step S09). Specifically, CPU 201 acquires a component which is specified by the component specification information included in the display command.

In the following step S10, CPU 201 displays the partial screen on display portion 206, and the process proceeds to step S11. The partial screen is displayed, in the tab screen in the first setting screen displayed on display portion 206, at the position which is specified by the position information included in the display command that is included in the partial definition data selected as the process target.

In step S11, CPU 201 determines whether there is a piece of partial definition data that has not been selected as a process target yet, among the one or more pieces of partial definition data read in step S07. If so, the process returns to step S08; otherwise, the process proceeds to step S12. In this manner, even in the case where two or more pieces of partial definition data are assigned to one tab screen, each piece of partial definition data is selected as a process target and subjected to the processes in steps S09 and S10.

In step S12, CPU 201 determines whether the current mode is the edit mode. The setting process is a process which is performed by CPU 201 when CPU 201 receives a command to execute the first driver program. In the case where a value prompting to start up in an edit mode has been added as an argument to the command to execute the first driver program, the first driver program is in the edit mode; otherwise, the program is in the normal mode which is different from the edit mode. If the current mode is the edit mode, the process proceeds to step S13; otherwise, the process proceeds to step S21.

In step S13, CPU 201 performs an editing screen displaying process, and the process proceeds to step S14. The editing screen displaying process, which will be described in detail later, is a process of displaying an editing screen which is a combination of the first setting screen with area identification images for identifying the respective partial screens included in the first setting screen.

In step S14, CPU 201 determines whether an edit completion signal has been input. The edit completion signal is input from the task that has output the command to execute the first driver program, which is here the task for executing the driver generating program. This will be described in detail later. If the edit completion signal is input, the process is terminated; otherwise, the process proceeds to step S15.

In step S15, CPU 201 determines whether an operation has been accepted. If CPU 201 detects an operation which is input to operation portion 207 by a user, the process proceeds to step S16; otherwise, the process returns to step S14. In step S16, the process branches on the basis of the accepted operation. If the operation is for selecting a partial screen, the process proceeds to step S18. If the operation is for switching between tab screens, the process proceeds to step S17. The operation for selecting a partial screen is the operation of designating an area identification image included in the editing screen which has been displayed on display portion 206 in step S13.

In step S17, CPU 201 sets the tab screen specified by the operation accepted in step S15, as a process target, and the process returns to step S07.

In step S18, CPU 201 specifies partial definition data on the basis of the operation accepted in step S15. Specifically, CPU 201 specifies the partial screen which corresponds to the area identification image specified by the operation accepted in step S15, among the area identification images included in the editing screen. CPU 201 then specifies the partial definition data which corresponds to the specified partial screen.

In the following step S19, CPU 201 outputs area identification image information. The area identification image information includes the area identification image specified by the operation accepted in step S15, and the position of the area identification image on the display surface of display portion 206.

In the following step S20, CPU 201 outputs the partial definition data specified in step S18, and the process returns to step S14. The output destination of the area identification image information and the partial definition data is the task that has output the command to execute the first driver program, which is here the task for executing the driver generating program.

In step S21, CPU 201 determines whether an operation has been accepted. CPU 201 is in a standby mode until a user inputs an operation into operation portion 207 (NO in step S21), and once the operation input to operation portion 207 is detected (YES in step S21), the process proceeds to step S22. In step S22, the process branches on the basis of the accepted operation.

If the operation is for instructing printing, the process proceeds to step S23. If the operation is for switching between tab screens, the process proceeds to step S24. If the operation is for inputting a setting value, the process proceeds to step S25. In the case where CPU 201 detects an operation performed on a function-based screen among the partial screens, CPU 201 determines that it is the operation for inputting a setting value.

In step S23, CPU 201 performs a print job generating process, and the process is terminated. The print job generating process will be described in detail later. In step S24, CPU 201 sets the tab screen specified by the operation accepted in step S21, as a process target, and the process returns to step S07. In step S25, CPU 201 sets the setting value, and the process returns to step S21. Specifically, CPU 201 sets the setting value which the user who operates PC 200 has input to operation portion 207 in accordance with the function-based screen among the partial screens, as the setting value which has been set for the function corresponding to the function-based screen. More specifically, CPU 201 stores a set of the function identification information for identifying the function corresponding to the function-based screen and the accepted setting value, into RAM 203.

FIG. 14 illustrates an example of the flow of an editing screen displaying process. The editing screen displaying process is a process performed in step S13 in the setting process shown in FIGS. 12 and 13. The tab screen as a process target has been selected prior to execution of the editing screen displaying process. Referring to FIG. 14, CPU 201 selects one partial screen as a process target, from among the one or more partial screens included in the tab screen which has been set as the process target (step S31). CPU 201 generates an area identification image corresponding to the partial screen as the process target (step S32). An area identification image is an image by which a partial screen can be identified. For example, the area identification image is an outline image enclosing the partial screen. The area identification image may include an image of partial definition data identification information for identifying the partial definition data corresponding to the partial screen.

In step S33, CPU 201 displays the generated area identification image overlaid on the setting screen displayed on display portion 206, and the process proceeds to step S34. In step S34, CPU 201 associates the area identification image corresponding to the partial screen as the process target, with the partial definition data corresponding to the partial screen, and the process proceeds to step S35. In step S35, CPU 201 determines whether there is a partial screen which has not been selected as a process target yet, among the one or more partial screens included in the tab screen as the process target. If there is a partial screen yet to be processed, the process returns to step S31; otherwise, the process returns to the setting process.

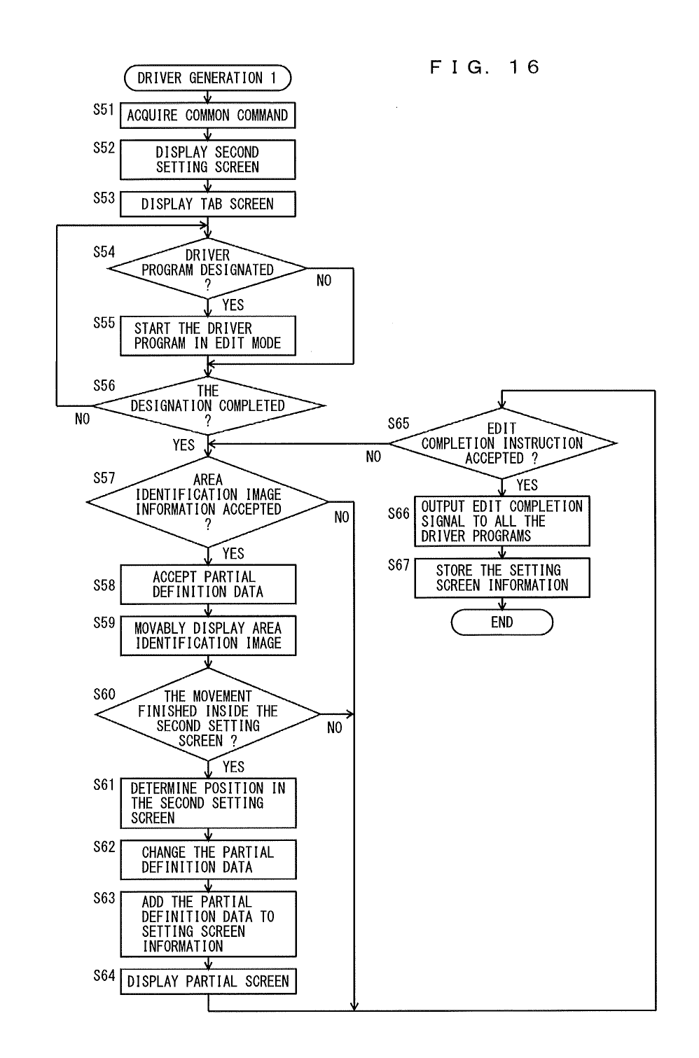

FIG. 15 is a flowchart illustrating an example of the flow of a print job generating process. The print job generating process is a process performed in step S23 in the setting process shown in FIGS. 12 and 13. Referring to FIG. 15, CPU 201 reads all sets of function identification information and setting values stored in RAM 203 (step S41). CPU 201 then selects one set, as a process target, from among the read sets of function identification information and setting values (step S42). Next, CPU 201 selects a print command (step S43), and stores it into RAM 203. Specifically, CPU 201 extracts, from partial definition data 97 stored in HDD 205, one or more pieces of partial definition data which correspond to the function specified by the function identification information selected as the process target. Then, CPU 201 selects, from one or more print commands included in the extracted piece(s) of partial definition data, a print command which corresponds to the setting value selected as the process target.

In step S44, CPU 201 determines whether there is a set of function identification information and setting value, which has not been set as a process target yet, among the sets of function identification information and setting values read in step S41. If there is a set yet to be processed, the process returns to step S42; otherwise, the process proceeds to step S45.

In step S45, CPU 201 generates a print job. Specifically, CPU 201 generates a print job including all the print commands stored in RAM 203 and data to be processed. CPU 201 transmits the generated print job to MFP 100 via network I/F 204 (step S46). The process then returns to the setting process.

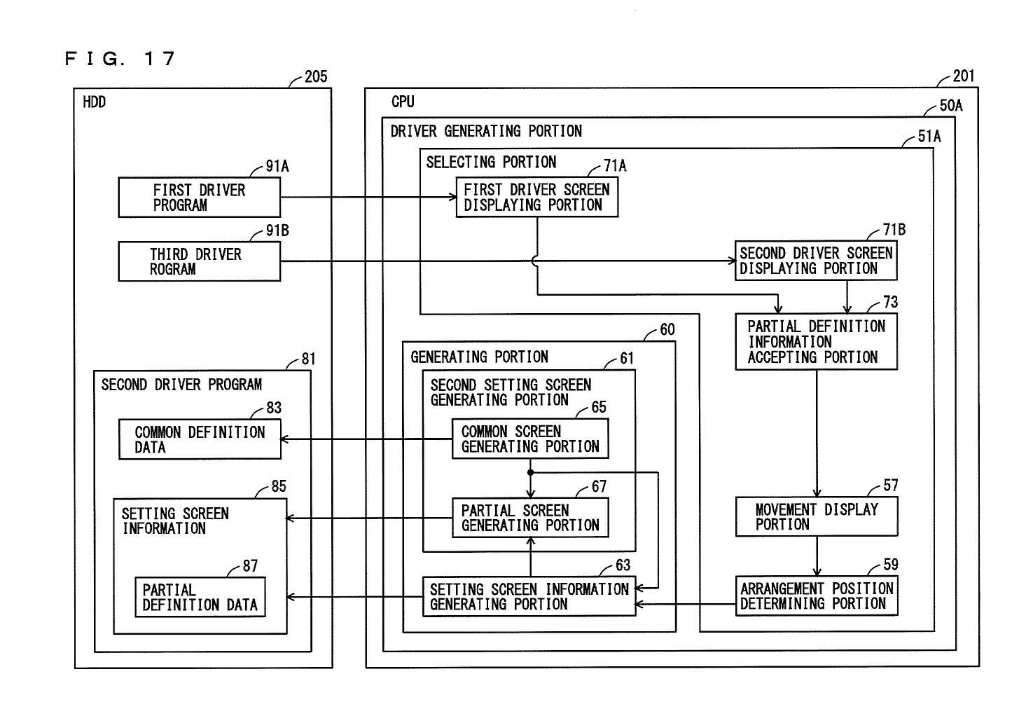

FIG. 16 is a flowchart illustrating an example of the flow of a driver generating process. The driver generating process is carried out by CPU 201 included in PC 200 as CPU 201 executes a driver generating program stored in ROM 202, HDD 205, or CD-ROM 209A.

Referring to FIG. 16, CPU 201 acquires a common command (step S51). CPU 201 reads common definition data which has been included in the driver generating program in advance, and acquires the common command included in the common definition data. CPU 201 then displays a second setting screen including the common screen (step S52).

In the following step S53, CPU 201 displays a tab screen on display portion 206. CPU 201 displays the tab screen in an area for displaying a tab screen, which area is included in the common definition data read in step S51. At this stage, no function-based screen to be included in the tab screen has been determined, and therefore, a plain tab screen is displayed on display portion 206. At this stage, the second setting screen including the common screen and the tab screen is displayed.

In the following step S54, CPU 201 determines whether a designation of a driver program has been accepted. When a user uses operation portion 207 to input an operation of designating a driver program, CPU 201 accepts the designation of the driver program. If the designation of a driver program has been accepted, the process proceeds to step S55; otherwise, the process proceeds to step S56, with step S55 being skipped. In step S55, CPU 201 starts the designated driver program in an edit mode, and the process proceeds to step S56. Specifically, an argument designating an edit mode is added to a command for instructing to execute the designated driver program, and CPU 201 is caused to execute the command. This generates in CPU 201 a task for executing the designated driver program. The task operates in the edit mode.

In step S56, CPU 201 determines whether the designation of the driver program has been completed. When a user uses operation portion 207 to input an operation for terminating the designation of the driver program, CPU 201 determines that the designation of the driver program has been completed. If it is determined that the designation of the driver program has not been completed yet, the process returns to step S54. If it is determined that the designation of the driver program has been completed, the process proceeds to step S57. In other words, one or more tasks for executing the driver programs are generated in CPU 201. It is here assumed that the task for executing the first driver program and the task for executing the third driver program are generated in CPU 201.

In step S57, CPU 201 determines whether area identification image information has been accepted. CPU 201 accepts the area identification image information from one of the task for executing the first driver program and the task for executing the third driver program. When a user designates one of the area identification images corresponding respectively to the partial screens included in the editing screen, the corresponding one of the task for executing the first driver program and the task for executing the third driver program outputs the area identification image information. The area identification image information includes the area identification image and a position of the area identification image on the display surface of display portion 206. If the area identification image information has been accepted, the process proceeds to step S58; otherwise, the process proceeds to step S65.

In step S58, CPU 201 accepts partial definition data. CPU 201 accepts the partial definition data from the one of the task for executing the first driver program and the task for executing the third driver program which has output the area identification image information.

In the following step S59, CPU 201 movably displays the area identification image. Specifically, CPU 201 displays the area identification image included in the area identification image information, movably at a position on the display surface. It is preferable that the area identification image is displayed first at a position, on display portion 206, which is specified by the position information included in the area identification image information.

In the following step S60, CPU 201 determines whether the area identification image, which has been movably displayed, finished the movement within the second setting screen. As a user performs a drag-and-drop operation, the area identification image is moved and placed in position. If the position at which the area identification image has been dropped falls within the second setting screen, the process proceeds to step S61; otherwise, the process proceeds to step S65.

In step S61, CPU 201 determines the position, in the second setting screen, at which the area identification image has finished the movement. CPU 201 then changes the partial definition data that was accepted in step S58 (step S62). Specifically, CPU 201 updates the position information of the display command included in the partial definition data, with the position determined in step S61. CPU 201 adds the partial definition data including the display command in which the position information has been changed, to setting screen information (step S63), and the process proceeds to step S64.

In step S64, CPU 201 displays a partial screen. CPU 201 displays the partial screen in accordance with the display command which is included in the partial definition data and in which the position information has been changed. As a result, the same partial screen as the one that has been designated by the user from among the partial screens which are each displayed by the task for executing the first driver program or the task for executing the third driver program, is displayed in the second setting screen.

In step S65, CPU 201 determines whether an edit completion instruction has been accepted. When a user uses operation portion 207 to input an operation for terminating the editing process, CPU 201 accepts the edit completion instruction. If the edit completion instruction has been accepted, the process proceeds to step S66; otherwise, the process returns to step S57.

In step S66, CPU 201 outputs an edit completion signal, and the process proceeds to step S67. CPU 201 outputs the edit completion signal to any task for executing the driver program that has been started in step S55, to thereby terminate all the tasks which have been started in the edit mode.

In step S67, CPU 201 stores the setting screen information into HDD 205, and the process is terminated. The setting screen information includes the partial definition data which has been added in step S63. It is therefore possible to readily generate the second driver program.

As described above, PC 200 according to the present embodiment functions as a driver generating apparatus by executing a driver generating program. When one or more pieces of partial definition data are selected by a user from a plurality of pieces of partial definition data determined by first driver program 91A for controlling MFP 100 or from a plurality of pieces of partial definition data determined by third driver program 91B for controlling MFP 100A, PC 200 generates a second driver program which includes the selected one or more pieces of partial definition data. Each of the plurality of pieces of partial definition data included in first driver program 91A associates a control command determining a prescribed process for controlling MFP 100, with a display command displaying a partial screen for accepting an operation by a user for the prescribed process. Each of the plurality of pieces of partial definition data included in third driver program 91B associates a control command determining a prescribed process for controlling MFP 100A, with a display command displaying a partial screen for accepting an operation by a user for the prescribed process. Therefore, at the stage of generating the second driver program, a user does not need to newly associate a control command with a user operation, and accordingly, the second driver program can be generated easily. This can improve the development efficiency of a driver program.

Further, when PC 200 generates a second setting screen of the second driver program, PC 200 determines one or more positions, within the second setting screen, at which one or more partial screens corresponding respectively to the one or more pieces of partial definition data selected from among a plurality of pieces of partial definition data of first driver program 91A or third driver program 91B are arranged, and changes the selected one or more pieces of partial definition data such that the partial screens are respectively arranged at the determined positions in the second setting screen. Accordingly, the partial screens determined by first driver program 91A or third driver program 91B can be arranged at arbitrary positions in the second setting screen determined by the second driver program.

PC 200 executes first driver program 91A, and executes a plurality of display commands included respectively in a plurality of pieces of partial definition data determined by first driver program 91A, to thereby generate a first setting screen having a plurality of partial screens arranged therein. PC 200 also generates an editing screen corresponding to the first setting screen, and displays the editing screen. Further, PC 200 executes third driver program 91B, and executes a plurality of display commands included respectively in a plurality of pieces of partial definition data determined by third driver program 91B, to thereby generate a first setting screen having one or more a plurality of partial screens arranged therein. PC 200 also generates an editing screen corresponding to the first setting screen, and displays the editing screen. Then, when a user designates one area identification image from among the plurality of area identification images included in the two editing screens, PC 200 specifies the partial definition data corresponding to the partial screen which is arranged at the same position as the designated area identification image. This allows the user to recognize the plurality of pieces of partial definition data determined by first driver program 91A or the plurality of pieces of partial definition data determined by third driver program 91B as the plurality of partial screens included in the first setting screen of the corresponding driver program. This can facilitate the user operation for selecting partial definition data.

Further, when a user designates one of the plurality of area identification images included in the editing screen displayed on display portion 206, PC 200 specifies the area identification image, and movably displays the specified area identification image. After the area identification image is moved, when the movement of the area identification image is finished, PC 200 determines the position, in the second setting screen, where the area identification image has finished the movement, as the arrangement position where the partial screen corresponding to the area identification image is arranged in the second setting screen. This facilitates the user operation for selecting the partial definition data determined by first driver program 91A or third driver program 91B, and also facilitates the user operation for determining the position where the partial screen is arranged in the second setting screen determined by the second driver program. For example, a user can specify the partial definition data and designate the position of the partial screen in the second setting screen, only through the operations of dragging the area identification image with the mouse, and moving the mouse pointer to a position falling within the second setting screen before dropping the area identification image.

The plurality of pieces of partial definition data determined by first driver program 91A include function definition data. The function definition data is data which corresponds to one of a plurality of functions included in MFP 100, and which associates one or more control commands corresponding to the function, among a plurality of control commands for controlling MFP 100, with a display command for displaying, as the partial screen, a function-based screen for setting a setting value for the function. The function definition data associates an operation input by a user in accordance with the function-based screen, with a control command for controlling MFP 100. Similarly, the function definition data included in the plurality of pieces of partial definition data determined by third driver program 91B associates an operation input by a user in accordance with the function-based screen, with a control command for controlling MFP 100A. Accordingly, when generating the second driver program, the user does not need to associate a control command with a setting value input by the user. This makes it possible to readily generate the second driver program.

Further, the plurality of pieces of partial definition data determined by first driver program 91A, or the plurality of pieces of partial definition data determined by third driver program 91B, include instruction definition data. The instruction definition data is data which corresponds to one of a plurality of operations which can be input by a user, and which associates a process executing command determining a process corresponding to the operation, with a display command for displaying, as the partial screen, an instruction-based screen for accepting the operation. The instruction definition data associates an operation input by a user in accordance with the instruction-based screen, with a process corresponding to the operation. Accordingly, when generating the second driver program, the user does not need to associate an operation input by a user, with a process corresponding to the operation. This makes it possible to readily generate the second driver program.

When the task for generating the driver generating program outputs an instruction for executing first driver program 91A (or third driver program 91B) in an edit mode, CPU 201 included in PC 200 executes first driver program 91A (or third driver program 91B) in the edit mode. In this case, the task for executing first driver program 91A (or third driver program 91B) displays an editing screen. When a user designates one of the plurality of area identification images included in the displayed editing screen, the task for executing first driver program 91A (or third driver program 91B) outputs partial definition data corresponding to the partial screen, among the plurality of partial screens, which is arranged at the same position as the designated area identification image, to the task for executing the driver generating program. As such, the task for executing first driver program 91A (or third driver program 91B) outputs the editing screen only when it is started in the edit mode. This configuration allows the user to designate whether to display the editing screen or not.

Further, for each of the plurality of partial screens with the outline images (area identification images) displayed on the editing screen, an image of partial definition data identification information for identifying partial definition data corresponding to the partial screen is combined to the editing screen, at a position a prescribed distance from the corresponding outline image (area identification image). For example, CPU 201 displays an image of the partial definition data identification information inside the outline image. This allows a user to specify the partial definition data when selecting the outline image in the editing screen. This also allows a user, when examining the sources of first driver program 91A, the second driver program, and third driver program 91B, to readily find out the partial definition data on the basis of the partial definition data identification information.

### Modification

In the embodiment described above, the task for executing the driver generating program was configured to start the task for executing the first driver program and the task for executing the third driver program in an edit mode and communicate with the tasks, to thereby generate a second driver program which includes pieces of partial definition data each included in the first driver program or the third driver program. The task for executing the driver generating program according to a modification is configured to acquire pieces of partial definition data by reading them directly from the first driver program and the third driver program, without starting the task for executing the first driver program and the task for executing the third driver program. The differences of PC 200 according to the modification from PC 200 according to the above-described embodiment will primarily be described below.

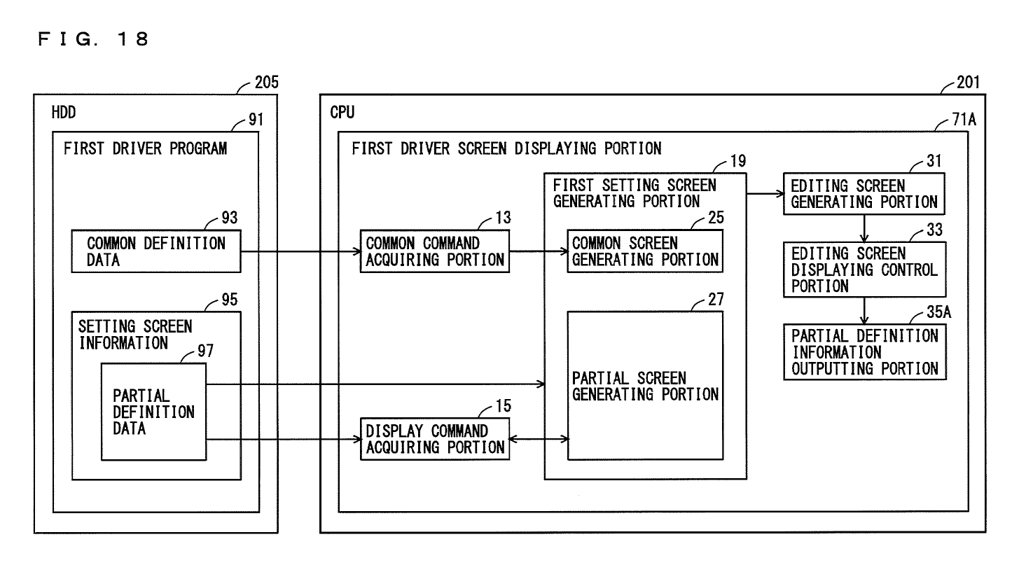

FIG. 17 is a block diagram showing, by way of example, the functions when a CPU included in a PC executes a driver generating program according to the modification, together with data stored in a HDD. The functions shown in FIG. 17 are formed in CPU 201 included in PC 200 as CPU 201 executes the driver generating program according to the modification stored in HDD 205 or CD-ROM 209A. In FIG. 17, a first driver program 91A and a third driver program 91B are stored in HDD 205. Each of first driver program 91A and third driver program 91B includes common definition data and setting screen information.

Referring to FIG. 17, CPU 201 includes a driver generating portion 50A as a task for executing the driver generating program of the modification. Driver generating portion 50A includes a selecting portion 51A and a generating portion 60. Generating portion 60 is the same as generating portion 60 in the block diagram shown in FIG. 10, and thus, the description thereof will not be repeated here.

Selecting portion 51A includes a first driver screen displaying portion 71A, a second driver screen displaying portion 71B, a partial definition information accepting portion 73, a movement display portion 57, and an arrangement position determining portion 59. Movement display portion 57 and arrangement position determining portion 59 are the same as movement display portion 57 and arrangement position determining portion 59 in the block diagram shown in FIG. 10, and thus, the description thereof will not be repeated here.

When a user designates first driver program 91A, first driver screen displaying portion 71A accesses first driver program 91A stored in HDD 205 to read the common definition data and the setting screen information, and displays a first setting screen on display portion 206. When a user designates third driver program 91B, second driver screen displaying portion 71B accesses third driver program 91B stored in HDD 205 to read the common definition data and the setting screen information, and displays a first setting screen on display portion 206. First driver screen displaying portion 71A and second driver screen displaying portion 71B are different from each other only in the driver program as a process target. Therefore, first driver screen displaying portion 71A will be described below representatively. It is noted that selecting portion 51A also includes a function which is operable, when a user designates a driver program other than first driver program 91A and third driver program 91B, to access the driver program to read common definition data and setting screen information, and display a first setting screen on display portion 206.

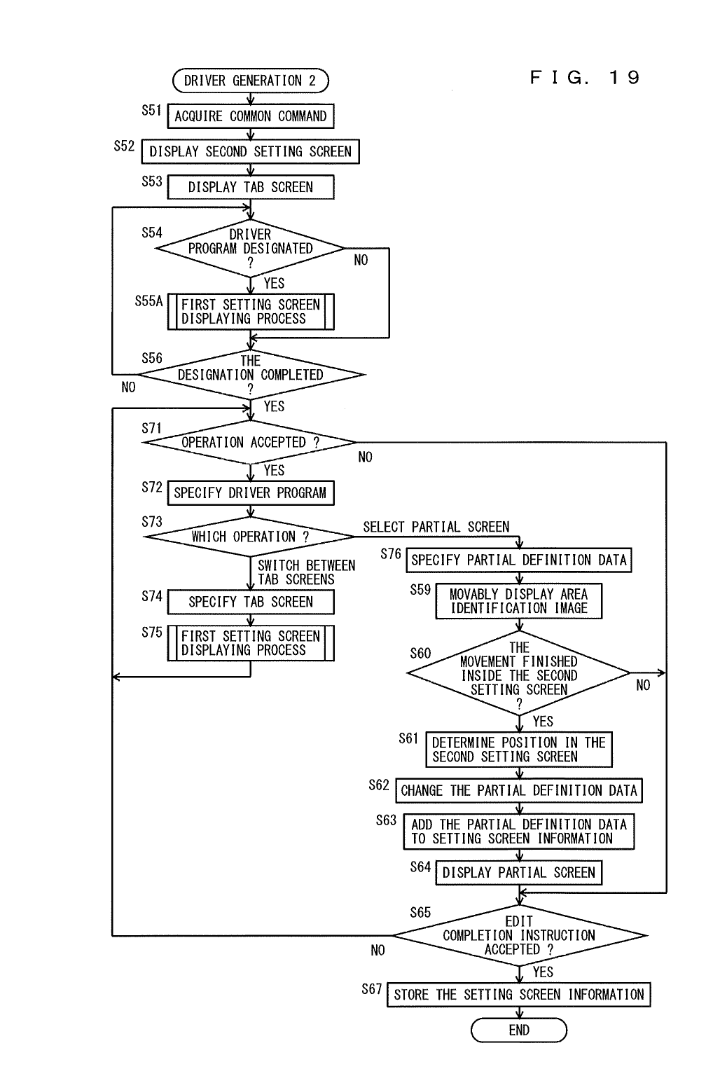

FIG. 18 shows, by way of example, the detailed functions of first driver screen displaying portion 71A. Referring to FIG. 18, first driver screen displaying portion 71A differs from first image processing apparatus control portion 11 shown in FIG. 5 in that print command acquiring portion 17, command outputting portion 23, and setting value accepting portion 21 are not included, and that partial definition information outputting portion 35 has been changed to a partial definition information outputting portion 35A. The other functions are identical to those shown in FIG. 5, and thus, the description thereof will not be repeated here.

When a user designates one of one or more area identification images included in an editing screen, partial definition information outputting portion 35A outputs partial definition information corresponding to the designated area identification image, to partial definition information accepting portion 73 (see FIG. 17). When a user inputs to operation portion 207 an operation of designating a position inside one of the one or more area identification images included in the editing screen, partial definition information outputting portion 35A outputs partial definition information corresponding to the designated area identification image, to partial definition information accepting portion 73. The partial definition information includes area identification image information, and partial definition data corresponding to the area identification image. The area identification image information includes the area identification image, and position information indicating the position, on display portion 206, at which the area identification image is displayed.

Returning to FIG. 17, partial definition information accepting portion 73 accepts the partial definition information which has been output from first driver screen displaying portion 71A or second driver screen displaying portion 71B. Partial definition information accepting portion 73 outputs the accepted partial definition information to movement display portion 57.

FIG. 19 is a flowchart illustrating an example of the flow of the driver generating process according to the modification. Referring to FIG. 19, the driver generating process according to the modification differs from the driver generating process shown in FIG. 16 in that step S55 has been changed to step S55A, steps S57 and S58 have been changed to steps S71 to S76, and step S66 has been deleted. The other steps are identical to those shown in FIG. 16, and thus, the description thereof will not be repeated here.

In step S55A, CPU 201 performs a first setting screen displaying process. The first setting screen displaying process, which will be described in detail later, is a process of reading common definition data and setting screen information included in the driver program that has been designated in step S54, to generate and display an editing screen.

Therefore, before the process proceeds to step S71, one or more driver programs are designated, and one or more editing screens corresponding respectively to the one or more driver programs are displayed. It is here assumed that first driver program 91A and third driver program 91B are designated, and an editing screen corresponding to first driver program 91A and an editing screen corresponding to third driver program 91B are displayed.

In step S71, CPU 201 determines whether an operation has been accepted. If CPU 201 detects an operation input to operation portion 207 by a user, the process proceeds to step S72; otherwise, the process proceeds to step S65. In step S65, CPU 201 determines whether an edit completion instruction has been accepted. If so, the process proceeds to step S67; otherwise, the process returns to step S71.

In step S72, CPU 201 specifies a driver program. If the operation accepted in step S71 was an operation of designating a position inside the editing screen corresponding to first driver program 91A, CPU 201 specifies first driver program 91A. If the operation accepted in step S71 was an operation of designating a position inside the editing screen corresponding to third driver program 91B, CPU 201 specifies third driver program 91B.

In step S73, the process branches on the basis of the operation accepted in step S71. If the operation accepted in step S71 was an operation for switching between tab screens, the process proceeds to step S74. If the operation accepted was an operation for selecting a partial screen, the process proceeds to step S76. The operation of selecting a partial screen is an operation of designating an area identification image which is included in the editing screen displayed on display portion 206 in step S55A.

In step S74, CPU 201 sets the tab screen specified by the operation accepted in step S71, as a process target, and the process proceeds to step S75. In step S75, CPU 201 performs the first setting screen displaying process, as in step S55A, and the process returns to step S71.

In step S76, CPU 201 specifies partial definition data, on the basis of the operation accepted in step S71, and the process proceeds to step S59. Specifically, CPU 201 specifies the partial screen which corresponds to the area identification image specified by the operation accepted in step S71 from among the area identification images included in the editing screen. CPU 201 then specifies the partial definition data which corresponds to the specified partial screen.

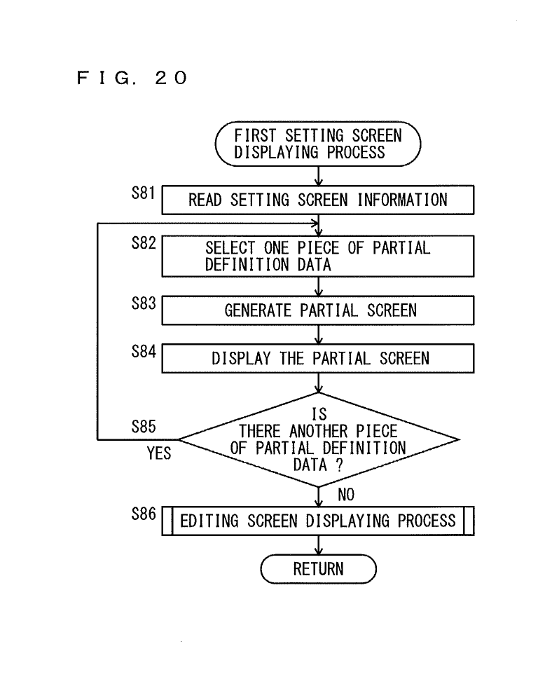

FIG. 20 illustrates an example of the flow of a first setting screen displaying process. The first setting screen displaying process is performed in steps S55A and S75 in FIG. 19. Referring to FIG. 20, in step S81, CPU 201 reads setting screen information. Before execution of the first setting screen displaying process, the driver program and the tab screen have been specified. Therefore, CPU 201 reads, from one or more pieces of partial definition data included in the setting screen information included in the specified driver program, one or more pieces of partial definition data which are associated with the specified tag screen.

In the following step S82, CPU 201 selects, as a process target, one of the one or more pieces of partial definition data which have been read. CPU 201 then generates a partial screen in accordance with the display command included in the partial definition data selected as the process target (step S83). Specifically, CPU 201 generates a partial screen by arranging a component specified by the component specification information included in the display command as the process target, at a position, within the screen displayed on display portion 206, specified by the position information included in the display command.

In the following step S84, CPU 201 displays the partial screen on display portion 206, and the process proceeds to step S85. In step S85, CPU 201 determines whether there is any piece of partial definition data that has not been selected as a process target yet, among the one or more pieces of partial definition data read in step S81. If there is a piece of partial definition data which has not been selected as a process target, the process returns to step S82; otherwise, the process proceeds to step S86. In this manner, even in the case where two or more pieces of partial definition data are assigned to one setting screen, each piece of partial definition data is selected as a process target and subjected to the processes in steps S83 and S84. In step S86, CPU 201 performs the editing screen displaying process shown in FIG. 14, and the process returns to the driver generating process shown in FIG. 19.

PC 200 according to the modification executes a plurality of display commands included respectively in a plurality of pieces of partial definition data determined by first driver program 91A, to thereby generate a first setting screen having a plurality of partial screens arranged therein. PC 200 also generates an editing screen corresponding to the first setting screen, and displays the editing screen. Further, PC 200 executes a plurality of display commands included respectively in a plurality of pieces of partial definition data determined by third driver program 91B, to thereby generate a first setting screen having a plurality of partial screens arranged therein. PC 200 also generates an editing screen corresponding to the first setting screen, and displays the editing screen. Then, when a user designates one area identification image from among the area identification images included in the two editing screens, PC 200 specifies the partial definition data corresponding to the partial screen which is arranged at the same position as the designated area identification image. This allows the user to recognize the plurality of pieces of partial definition data determined by first driver program 91A or third driver program 91B, as the plurality of partial screens included in the first setting screen of the corresponding driver program. This can facilitate the user operation for selecting partial definition data.

In the above embodiment, the description has been made of the case where, in print system 1, PC 200 functions as a driver generating apparatus which generates a second driver program for controlling MFP 100B. In addition thereto, the present invention may of course be understood as a driver generating method or a driver generating program for causing CPU 201 included in PC 200 to perform the processing shown in FIG. 16 or FIGS. 19 and 20 to thereby cause PC 200 to function as the driver generating apparatus. Furthermore, the present invention may also be understood as a control method for causing a computer to perform the processing shown in FIGS. 12 to 15, or as a driver program for causing a computer to perform the control method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A driver generating apparatus comprising:
a selecting portion to select one or more pieces of partial definition data from among a plurality of pieces of partial definition data determined by a first driver program for controlling an image processing apparatus, each piece of the partial definition data associating a control command determining a prescribed process with a display command for displaying a partial screen for accepting an operation by a user in relation to said prescribed process; and
a generating portion to generate a second driver program including said selected one or more pieces of partial definition data.

2. The driver generating apparatus according to claim 1, further comprising:
a second setting screen generating portion to generate a second setting screen in which, for each of said selected one or more pieces of partial definition data, said partial screen corresponding to the partial definition data is arranged;
an arrangement position determining portion to determine a position at which said partial screen is arranged in said second setting screen; and
a setting screen information generating portion to change said partial definition data such that said partial screen is arranged at said determined position in said second setting screen.

3. The driver generating apparatus according to claim 1, further comprising an image processing apparatus control portion to execute said first driver program,
said image processing apparatus control portion including
a first setting screen generating portion to generate a first setting screen having a plurality of partial screens arranged therein by executing the plurality of display commands included respectively in the plurality of pieces of partial definition data determined by said first driver program,
an editing screen generating portion to generate an editing screen by combining, to said generated first setting screen, a plurality of area identification images for respectively identifying said plurality of partial screens included in said first setting screen, at the same positions where the corresponding partial screens are arranged in said first setting screen,
an editing screen displaying control portion to display said generated editing screen, and
a partial definition data specifying portion operable, in response to designation by a user of one of the plurality of area identification images included in said displayed editing screen, to specify said partial definition data corresponding to the partial screen, among said plurality of partial screens, which is arranged at the same position as said designated area identification image, wherein
said selecting portion selects the partial definition data specified by said partial definition data specifying portion.

4. The driver generating apparatus according to claim 3, wherein
said generating portion includes
a second setting screen generating portion to generate a second setting screen in which, for each of said selected one or more pieces of partial definition data, said partial screen corresponding to the partial definition data is arranged, and
a second setting screen displaying control portion to display said generated second setting screen,
said partial definition data specifying portion is operable, in response to designation by a user of one of the plurality of area identification images included in said displayed editing screen, to specify said designated area identification image together with said partial definition data,
said selecting portion includes
a movement display portion to display said specified area identification image in a movable manner, and
an arrangement position determining portion operable, in the case where said movably displayed area identification image has finished movement in said displayed second setting screen, to determine a position within said second setting screen at which the movement of said area identification image has finished, as an arrangement position within said second setting screen at which the partial screen corresponding to said area identification image is arranged, and
said generating portion further includes a setting screen information generating portion to change said partial definition data such that said partial screen is arranged at said determined position in said second setting screen.

5. The driver generating apparatus according to claim 1, wherein
said selecting portion includes
a first setting screen generating portion to generate a first setting screen having a plurality of partial screens arranged therein by executing a plurality of display commands included respectively in the plurality of pieces of partial definition data determined by said first driver program,
an editing screen generating portion to generate an editing screen by combining, to said generated first setting screen, a plurality of area identification images for respectively identifying said plurality of partial screens included in said first setting screen, at the same positions where the corresponding partial screens are arranged in said first setting screen,
an editing screen displaying control portion to display said generated editing screen, and
a partial definition data specifying portion operable, in response to designation by a user of one of said plurality of area identification images included in said displayed editing screen, to specify said partial definition data corresponding to said designated area identification image, and
said selecting portion selects the partial definition data specified by said partial definition data specifying portion.

6. The driver generating apparatus according to claim 5, wherein
said generating portion includes
a second setting screen generating portion to generate a second setting screen in which, for each of said selected one or more pieces of partial definition data, said partial screen corresponding to the partial definition data is arranged, and
a second setting screen displaying control portion to display said generated second setting screen,
said partial definition data specifying portion is operable, in response to designation by a user of one of said area identification images included in said displayed editing screen, to specify said designated area identification image together with said partial definition data,
said selecting portion further includes
a movement display portion to display said specified area identification image in a movable manner, and
an arrangement position determining portion operable, in the case where said movably displayed area identification image has finished movement in said displayed second setting screen, to determine a position within said second setting screen at which the movement of said area identification image has finished, as an arrangement position within said second setting screen at which the partial screen corresponding to said area identification image is arranged, and
said generating portion further includes a setting screen information generating portion to change said partial definition data such that said partial screen is arranged at said determined position in said second setting screen.

7. The driver generating apparatus according to claim 1, wherein said plurality of pieces of partial definition data include function definition data which corresponds to one of a plurality of functions included in said image processing apparatus, and which associates one or more control commands corresponding to the function, among a plurality of control commands for controlling said image processing apparatus, with a display command for displaying, as said partial screen, a function-based screen for setting a setting value for the function.

8. The driver generating apparatus according to claim 1, wherein said plurality of pieces of partial definition data include instruction definition data which corresponds to one of a plurality of operations that can be input by a user, and which associates a process executing command determining a process corresponding to the operation, with a display command for displaying, as said partial screen, an instruction-based screen for accepting the operation.

9. A driver generating method for causing a computer to perform:
a selecting step of selecting one or more pieces of partial definition data from among a plurality of pieces of partial definition data determined by a first driver program for controlling an image processing apparatus, each piece of the partial definition data associating a control command determining a prescribed process with a display command for displaying a partial screen for accepting an operation by a user in relation to said prescribed process; and
a generating step of generating a second driver program including said selected one or more pieces of partial definition data.

10. A non-transitory computer-readable recording medium encoded with a driver generating program for causing a computer to perform:
a selecting step of selecting one or more pieces of partial definition data from among a plurality of pieces of partial definition data determined by a first driver program for controlling an image processing apparatus, each piece of the partial definition data associating a control command determining a prescribed process with a display command for displaying a partial screen for accepting an operation by a user in relation to said prescribed process; and
a generating step of generating a second driver program including said selected one or more pieces of partial definition data.
